(19) United States
(12) Patent Application Publication
(10) Pub. No.: US 2013/0225740 A1
(43) Pub. Date: Aug. 29, 2013

(54) PRESSURE-SENSITIVE ADHESIVE COMPOSITION, PRESSURE-SENSITIVE ADHESIVE LAYER, AND PRESSURE-SENSITIVE ADHESIVE SHEET

(71) Applicant: Nitto Denko Corporation, (US)

(72) Inventors: Toru ISEKI, Osaka (JP); Shogo SASAKI, Osaka (JP); Souya JO, Osaka (JP); Masahiko ANDO, Osaka (JP)

(73) Assignee: NITTO DENKO CORPORATION, Osaka (JP)

(21) Appl. No.: 13/772,763

(22) Filed: Feb. 21, 2013

(30) Foreign Application Priority Data
Feb. 23, 2012 (JP) 2012-037863
Dec. 10, 2012 (JP) 2012-269503

(51) Int. Cl. C09J 133/08

(52) U.S. Cl. CPC C09J 133/08
USPC 524/376

(57) ABSTRACT

The present invention provides a pressure-sensitive adhesive composition comprising: an acrylic polymer (A) having a polyoxyalkylene chain in a side chain and a polyoxyalkylene oligomer (B), wherein a content of the polyoxyalkylene oligomer (B) is 5 to 150 parts by weight with respect to 100 parts by weight of the acrylic polymer (A), a pressure-sensitive adhesive layer comprising the pressure-sensitive adhesive composition, and a pressure-sensitive adhesive sheet comprising a backing and the pressure-sensitive adhesive layer.

This application claims priority under 35 U.S.C. Section 119 to Japanese Patent Application No. 2012-037863 filed on Feb. 23, 2012 and Japanese Patent Application No. 2012-269503 filed on Dec. 10, 2012, which are herein incorporated by reference.

### BACKGROUND OF THE INVENTION

1. Field of the Invention

The present invention relates to a pressure-sensitive adhesive sheet excellent in wettability, and to a pressure-sensitive adhesive layer and a pressure-sensitive adhesive composition which are used for the sheet.

2. Description of the Related Art

A pressure-sensitive adhesive sheet has a gel-like soft pressure-sensitive adhesive layer on a backing such as a plastic film or paper. The pressure-sensitive adhesive layer, which is a solid, shows wettability to an adherend, thereby exhibiting an adhesive strength. That is, the pressure-sensitive adhesive layer is required to show sufficient wettability to an adherend. On the other hand, the pressure-sensitive adhesive layer is required to have such a cohesive force (stiffness) that the layer can resist peeling. Thus, the pressure-sensitive adhesive sheet is designed in consideration of the wettability and cohesive force as contradictory characteristics.

Therefore, the pressure-sensitive adhesive sheet, when attached to an adherend, is generally pressurized, and in some cases, is pressurized in a heated state, thereby being applied so as to be brought into sufficiently close contact with the adherend. When the pressurization and heating can be performed in the application as described above, it is also possible to use a pressure-sensitive adhesive tape having poor wettability. However, when the adherend is a very small part or is damaged by the heating, such application becomes difficult.

Further, as a case where the wettability to an adherend becomes a problem, a case where air bubbles are trapped between the adherend and the pressure-sensitive adhesive sheet is envisaged. For example, it is known that, in order to prevent air bubbles from remaining in attaching a decorative film, convex protrusions are provided or concave streaks are formed on a pressure-sensitive adhesive layer, thereby removing the air bubbles. However, none of those techniques essentially improves the wettability of the pressure-sensitive adhesive sheet.

As a method of improving the wettability of the pressure-sensitive adhesive sheet, there is known a method involving employing a graft polymer structure having an alkylene oxide in a side chain as a structure of an acrylic polymer constituting a pressure-sensitive adhesive layer. That is, Japanese Patent Application Laid-open No. 2005-200540 discloses a surface protective film including a supporting film and a pressure-sensitive adhesive layer formed on the supporting film, the pressure-sensitive adhesive layer being obtained by cross-linking a pressure-sensitive adhesive composition which contains a (meth)acrylic (co)polymer including, as monomer components, 51 to 100 wt % of a (meth)acrylic acid alkylene oxide adduct, 0 to 49 wt % of a (meth)acrylic monomer except the foregoing, and 0 to 49 wt % of any other polymerizable monomer, and which contains a cross-linking agent. Further, Japanese Patent Application Laid-open No. 2009-227737 discloses a re-peelable pressure-sensitive adhesive product including a supporting backing and a pressure-sensitive adhesive layer formed on at least one surface of the supporting backing, the pressure-sensitive adhesive layer being obtained from a solvent type re-peelable pressure-sensitive adhesive composition in which a cross-linking agent is compounded and used and which includes a pressure-sensitive adhesive polymer, the composition being characterized in that the pressure-sensitive adhesive polymer is a graft and/or block polymer which has a polymer structure having a glass transition temperature of 0° C. or more and has a polymer structure synthesized from raw material monomer components which include, as essential components, an alkyl (meth)acrylate (A) having an alkyl group containing 4 to 12 carbon atoms, a long chain moiety-containing monomer (B) containing an alkylene oxide chain and/or a long chain alkyl group, and a functional group-containing monomer (C) and which include any other monomer (D) as necessary.

However, the product according to the invention described in Japanese Patent Application Laid-open No. 2009-227737 requires 20 seconds or more to wet the entirety of even such a narrow range of an adhesion area as 4 cm by 4 cm, and thus does not have sufficient wettability.

### SUMMARY OF THE INVENTION

In view of the foregoing, the present invention provides a pressure-sensitive adhesive composition and a pressure-sensitive adhesive layer which are excellent in wettability, and a pressure-sensitive adhesive sheet which is obtained by using the composition and the layer, in order to solve problems in a conventional acrylic pressure-sensitive adhesive.

The inventors of the present invention have made extensive studies in order to solve such problems. As a result, the inventors have found that the problems can be solved by a pressure-sensitive adhesive sheet including a backing and a pressure-sensitive adhesive layer formed on the backing, the pressure-sensitive adhesive layer being formed of a pressure-sensitive adhesive composition containing a predetermined amount of a polyoxyalkylene oligomer with respect to an acrylic polymer having a polyoxyalkylene chain in a side chain. Thus, the present invention has been completed.

The reason why the wettability of a pressure-sensitive adhesive can be improved in the present invention resides in introducing a polyoxyalkylene chain into a side chain of an acrylic polymer and further compounding a predetermined amount of a polyoxyalkylene oligomer into a composition. The polyoxyalkylene chain introduced into the side chain of the acrylic polymer is estimated to contribute to the improvement in wettability for the following reason: the chain allows an ether bond, which is a bond having low rotation energy, to be introduced in a polymer skeleton, and hence increases a degree of freedom in molecular rotation. The polyoxyalkylene oligomer compounded into the composition is estimated to contribute to the improvement in wettability for the following reasons: the oligomer has an ether bond, which is a bond having low rotation energy, and hence increases a degree of freedom in molecular rotation; and the oligomer has a small molecular weight as compared to that of the acrylic polymer, and hence is likely to be present on the surface of the pressure-sensitive adhesive. In particular, the combined use of the acrylic polymer and the polyoxyalkylene oligomer allows the ether bond introduced into the acrylic polymer and the ether bond compounded into the pressure-sensitive adhesive composition, each of which is a bond having low rotation energy, to be present on the surface of the pressure-sensitive adhesive, and allows their synergistic effect to be provided. Hence, unprecedentedly excellent wettability can be exhibited.

The present invention provides a pressure-sensitive adhesive composition, including: an acrylic polymer (A) having a polyoxyalkylene chain in a side chain; and a polyoxyalkylene oligomer (B), in which the content of the polyoxyalkylene oligomer (B) is 5 to 150 parts by weight with respect to 100 parts by weight of the acrylic polymer (A).

In particular, in the pressure-sensitive adhesive composition of the present invention, the acrylic polymer (A) having a polyoxyalkylene chain in a side chain suitably has a polyoxypropylene chain as the polyoxyalkylene chain, suitably has a polyoxyalkylene alkyl ether chain as the polyoxyalkylene chain, and suitably has a polyoxyalkylene chain having an addition molar number of oxyalkylene units of 3 or more. The acrylic polymer particularly suitably has a trioxypropylene monomethyl ether chain and/or a hexaoxypropylene monomethyl ether chain as the polyoxyalkylene chain.

Further, the acrylic polymer (A) having a polyoxyalkylene chain in a side chain includes, as a monomer component, a monomer having a polyoxyalkylene chain, in which the content of the monomer having a polyoxyalkylene chain is 3 to 78 wt % with respect to the total weight of all monomer components. In particular, the acrylic polymer (A) having a polyoxyalkylene chain in a side chain includes, as monomer components, 2 to 96.9 wt % of an alkyl (meth)acrylate having an alkyl group containing 4 to 18 carbon atoms, 3 to 78 wt % of a monomer having a polyoxyalkylene chain, 0.1 to 8 wt % of a functional group-containing monomer, and 0 to 12 wt % of any other copolymerizable monomer.

The monomer having a polyoxyalkylene chain is suitably trioxypropylene monomethyl ether (meth)acrylate or hexaoxypropylene monomethyl ether (meth)acrylate.

In the pressure-sensitive adhesive composition of the present invention, the polyoxyalkylene oligomer (B) is suitably a polyoxypropylene. Further, the polyoxyalkylene oligomer (B) is suitably a polyoxyalkylene alkyl ether. Further, the polyoxyalkylene oligomer (B) suitably has a molecular weight of 200 to 20,000. In particular, the polyoxyalkylene oligomer (B) is suitably a polyoxypropylene alkyl ether, and an alkyl group constituting the polyoxyalkylene alkyl ether is suitably a methyl group or a 2-ethylhexyl group.

In the pressure-sensitive adhesive composition of the present invention, it is suitable to use, as the acrylic polymer (A), an acrylic polymer having a polyoxypropylene monoalkyl ether chain and/or a hexaoxypropylene monomethyl ether chain, and to use, as the polyoxyalkylene oligomer (B), a polyoxypropylene alkyl ether.

The present invention also provides the pressure-sensitive adhesive composition, further including 1 to 10 parts by weight of a cross-linking agent with respect to 100 parts by weight of the acrylic polymer (A). In particular, the cross-linking agent is suitably an isocyanate-based cross-linking agent.

The present invention also provides a pressure-sensitive adhesive layer, including the pressure-sensitive adhesive composition, and a pressure-sensitive adhesive sheet, including: a backing; and the pressure-sensitive adhesive layer formed on the backing.

The pressure-sensitive adhesive composition, pressure-sensitive adhesive layer, and pressure-sensitive adhesive sheet of the present invention are excellent in wettability as compared to a conventional acrylic pressure-sensitive adhesive sheet. Therefore, the pressure-sensitive adhesive sheet of the present invention can come into sufficiently close contact with an adherend even without any particular pressurization when attached to the adherend, thereby sufficiently preventing the inclusion of air bubbles or the like. Accordingly, the pressure-sensitive adhesive sheet can be utilized as various pressure-sensitive adhesive sheets.

### BRIEF DESCRIPTION OF THE DRAWING

FIG. 1 is a schematic view illustrating an evaluation method for wettability in Examples.

### DETAILED DESCRIPTION OF THE PREFERRED EMBODIMENTS

Hereinafter, embodiments of the present invention are described in detail.

A pressure-sensitive adhesive composition of the present invention contains 5 to 150 parts by weight of a polyoxyalkylene oligomer (B) with respect to 100 parts by weight of an acrylic polymer (A) having a polyoxyalkylene chain in a side chain.

(Acrylic Polymer (A) Having Polyoxyalkylene Chain in Side Chain)

The acrylic polymer (A) having a polyoxyalkylene chain in a side chain (hereinafter, sometimes simply referred to as acrylic polymer (A)) which may be used in the present invention is not particularly limited as long as the polymer has an acrylic polymer skeleton in a main chain and has a polyoxyalkylene chain in a side chain. Such acrylic polymer (A) can be described as the following general formula (1).

—[CH₂C(R¹)COOR³]—[CH₂C(R²)COOR⁴]— (1)

In the general formula (1), R⁴ and R² each represent hydrogen or a methyl group, R³ represents an alkyl group containing 4 to 18 carbon atoms, R⁴ represents a polyoxyalkylene chain, and repeating units derived from monomer components shown in the parentheses “[ ]” are linked together. It should be noted that the acrylic polymer (A) may include a repeating unit having a functional group (e.g., a carboxyl group, a hydroxyl group, or an amino group) as necessary.

The acrylic polymer (A) used in the present invention may have one kind of polyoxyalkylene chain or may have two or more kinds of polyoxyalkylene chains. That is, one kind or two or more kinds of polyoxyalkylene chain R⁴-containing units may be present in the general formula (1).

The acrylic polymer (A) having a polyoxyalkylene chain in a side chain used in the present invention preferably contains, as a monomer component, 3 to 78 wt % of a monomer having a polyoxyalkylene chain with respect to the total weight of all monomer components. The acrylic polymer (A) particularly preferably contains, as monomer components, 2 to 96.9 wt % of an alkyl (meth)acrylate having an alkyl group containing 4 to 18 carbon atoms, 3 to 78 wt % of a monomer having a polyoxyalkylene chain, 0.1 to 8 wt % of a functional group-containing monomer, and 0 to 12 wt % of any other copolymerizable monomer. When the monomer having a polyoxyalkylene chain is contained in the range of 3 to 78 wt % as the monomer component constituting the acrylic polymer (A), there is an advantage in that, when an ether bond, which is a bond having low rotation energy (leading to a high degree of freedom in molecular rotation), is introduced into the polymer, the number of ether bonds which can be present on the surface of a pressure-sensitive adhesive is large, and thus wettability can be improved.

Such acrylic polymer (A) having a polyoxyalkylene chain in a side chain may be synthesized by, for example, copolymerization of an alkyl (meth)acrylate constituting a main chain, a monomer having a polyoxyalkylene chain for introducing the polyoxyalkylene chain into the side chain, and as necessary, any other monomer. Alternatively, the polyoxyalkylene chain may be introduced through a reaction for bonding the polyoxyalkylene chain to an acrylic polymer having an appropriate functional group (e.g., a carboxyl group or a hydroxyl group). In the present invention, a synthesis method involving copolymerization with a monomer having a polyoxyalkylene chain is preferred from the viewpoints of, for example, ease of introduction and ease of adjustment of an introduction amount.

A synthesis method for the acrylic polymer (A) involving copolymerization of an alkyl (meth)acrylate constituting a main chain and a polyoxyalkylene (meth)acrylate for introducing a polyoxyalkylene chain into a side chain is described below.

In the present invention, the acrylic polymer (A) having a polyoxyalkylene chain in a side chain may be obtained by, for example, copolymerization of a monomer having a polyoxyalkylene chain, an alkyl (meth)acrylate having an alkyl group containing 4 to 18 carbon atoms, a functional group-containing monomer, and any other appropriate copolymerizable monomer.

The monomer having a polyoxyalkylene chain which may be used in the present invention is not particularly limited as long as the monomer includes a polymerizable functional group copolymerizable with an alkyl (meth)acrylate constituting a main chain, and a polyoxyalkylene chain in a molecule. The polymerizable functional group is preferably a radically polymerizable double bond from the viewpoint of its reactivity, and examples thereof may include an acryloyl group, a methacryloyl group, and a styryl group. Of those, an acryloyl group or a methacryloyl group, which is easily copolymerized with the alkyl (meth)acrylate, is preferred.

That is, in the present invention, the monomer having a polyoxyalkylene chain is preferably a polyoxyalkylene (meth)acrylate which has an acryloyl group or a methacryloyl group as a polymerizable functional group and has a polyoxyalkylene chain in a side chain. It should be noted that the expression “(meth)acrylate” as used in the present invention refers to an acrylate and/or a methacrylate.

The polyoxyalkylene (meth)acrylate can be represented by the following general formula (2).

R⁵—(R⁶O)ₙ—R⁷ (2)

In the general formula (2), R⁵ represents a substituent including an acryloyl group (CH₂═CHCOO—) or a methacryloyl group (CH₂═C(CH₃)COO—).

In the general formula (2), R⁶ preferably represents a C₂ to C₄ alkylene group, and examples thereof may include an ethylene group (—CH₂CH₂—), a propylene group (—CH₂CH(CH₃)—), a butylene group (—CH₂CH(CH₂CH₃)—), and a tetramethylene group (—CH₂CH₂CH₂CH₂—). Further, R⁶ may represent one kind of alkylene group or may represent two or more kinds of alkylene groups. That is, in the general formula (2), (R⁶O)ₙ may represent a block copolymer or random copolymer of two or more kinds of oxyalkylene groups. In the present invention, R⁶ preferably represents a propylene group particularly from the viewpoint of having a low freezing point (pour point) and high lipophilicity (low surface free energy).

In the general formula (2), R⁷ represents hydrogen, a C₁ to C₂₀ alkyl group (aliphatic hydrocarbon group), or an aromatic substituent. Examples of the C₁ to C₂₀ alkyl group may include a methyl group, an ethyl group, a propyl group, an isopropyl group, a butyl group, an isobutyl group, a t-butyl group, a pentyl group, a hexyl group, a heptyl group, an octyl group, an isooctyl group, a 2-ethylhexyl group, a nonyl group, a decyl group, an isodecyl group, an undecyl group, a tridecyl group, a tetradecyl group, a pentadecyl group, a hexadecyl group, a heptadecyl group, an octadecyl group, and an eicosyl group. Further, examples of the aromatic substituent may include a phenyl group, a methylphenyl group, and a naphthyl group. In the present invention, R⁷ represents preferably an alkyl group, more preferably a methyl group, an ethyl group, or a 2-ethylhexyl group, from the viewpoint of having high lipophilicity (low surface free energy).

Further, in the general formula (2), n represents an addition molar number of oxyalkylene units. In the present invention, n represents 2 or more, preferably 3 or more, more preferably 3 to 18, still more preferably 6 to 15. That the addition molar number n of oxyalkylene units represents 2 or more means that a chain of ether bonds, each of which is a bond having low rotation energy (leading to a high degree of freedom in molecular rotation), is long in the polymer, and there is an advantage in that the number of ether bonds which can be present on the surface of a pressure-sensitive adhesive is large, and thus wettability can be improved. On the other hand, when the addition molar number n represents less than 2, an ether bond for improving the wettability is buried in the pressure-sensitive adhesive, and thus the number of ether bonds present on the surface of the pressure-sensitive adhesive becomes small in some cases. Further, when the addition molar number n represents more than 18, some polyoxyalkylene (meth)acrylates have high viscosities or are present as solids at a use temperature (25° C.) and thus are poor in handleability or form gels during polymerization in some cases.

It should be noted that, in the present invention, the addition molar number n of oxyalkylene units is an addition molar number derived from an individual molecular structure. Further, in the case of using a commercially available product or the like, which includes a mixture of a plurality of addition molar numbers n's of oxyalkylene units, an average calculated from its number average molecular weight is used. The number average molecular weight can be measured by gel permeation chromatography (GPC) and calculated in terms of polystyrene.

Specific examples of the polyoxyalkylene (meth)acrylate which may be used in the present invention may include a polyoxyethylene (meth)acrylate represented by the general formula (2) where R⁶ represents an ethylene group, a polyoxypropylene (meth)acrylate represented by the general formula (2) where R⁶ represents a propylene group, a polyoxybutylene (meth)acrylate represented by the general formula (2) where R⁶ represents a butylene group, and a polyoxytetramethylene (meth)acrylate represented by the general formula (2) where R⁶ represents a tetramethylene group.

Specific examples of the polyoxyethylene (meth)acrylate may include:

a dioxyethylene (meth)acrylate type having an addition molar number n of oxyethylene units of 2, such as dioxyethylene (meth)acrylate, dioxyethylene monomethyl ether (meth)acrylate, dioxyethylene monoethyl ether (meth)acrylate, dioxyethylene monobutyl ether (meth)acrylate, or dioxyethylene monophenyl ether (meth)acrylate;

a trioxyethylene (meth)acrylate type having an addition molar number n of oxyethylene units of 3, such as trioxyethylene (meth)acrylate, trioxyethylene monomethyl ether (meth)acrylate, trioxyethylene monoethyl ether (meth)acrylate, trioxyethylene monobutyl ether (meth)acrylate, or trioxyethylene monophenyl ether (meth)acrylate;

a tetraoxyethylene (meth)acrylate type having an addition molar number n of oxyethylene units of 4, such as tetraoxyethylene (meth)acrylate, tetraoxyethylene monomethyl ether (meth)acrylate, tetraoxyethylene monoethyl ether (meth)acrylate, tetraoxyethylene monobutyl ether (meth)acrylate, or tetraoxyethylene monophenyl ether (meth)acrylate;

a hexaoxyethylene (meth)acrylate type having an addition molar number n of oxyethylene units of 6, such as hexaoxyethylene (meth)acrylate, hexaoxyethylene monomethyl ether (meth)acrylate, hexaoxyethylene monoethyl ether (meth)acrylate, hexaoxyethylene monobutyl ether (meth)acrylate, or hexaoxyethylene monophenyl ether (meth)acrylate; and

a polyoxyethylene (meth)acrylate type having an addition molar number n of oxyethylene units of 10 or more, such as a polyoxyethylene (meth)acrylate, a polyoxyethylene monomethyl ether (meth)acrylate, a polyoxyethylene monoethyl ether (meth)acrylate, a polyoxyethylene monobutyl ether (meth)acrylate, or a polyoxyethylene monophenyl ether (meth)acrylate.

Specific examples of the polyoxypropylene (meth)acrylate may include:

a dioxypropylene (meth)acrylate type having an addition molar number n of oxypropylene units of 2, such as dioxypropylene (meth)acrylate, dioxypropylene monomethyl ether (meth)acrylate, dioxypropylene monoethyl ether (meth)acrylate, dioxypropylene monobutyl ether (meth)acrylate, or dioxypropylene monophenyl ether (meth)acrylate;

a trioxypropylene (meth)acrylate type having an addition molar number n of oxypropylene units of 3, such as trioxypropylene (meth)acrylate, trioxypropylene monomethyl ether (meth)acrylate, trioxypropylene monoethyl ether (meth)acrylate, trioxypropylene monobutyl ether (meth)acrylate, or trioxypropylene monophenyl ether (meth)acrylate;

a tetraoxypropylene (meth)acrylate type having an addition molar number n of oxypropylene units of 4, such as tetraoxypropylene (meth)acrylate, tetraoxypropylene monomethyl ether (meth)acrylate, tetraoxypropylene monoethyl ether (meth)acrylate, tetraoxypropylene monobutyl ether (meth)acrylate, or tetraoxypropylene monophenyl ether (meth)acrylate;

a hexaoxypropylene (meth)acrylate type having an addition molar number n of oxypropylene units of 6, such as hexaoxypropylene (meth)acrylate, hexaoxypropylene monomethyl ether (meth)acrylate, hexaoxypropylene monoethyl ether (meth)acrylate, hexaoxypropylene monobutyl ether (meth)acrylate, or hexaoxypropylene monophenyl ether (meth)acrylate; and

a polyoxypropylene (meth)acrylate type having an addition molar number n of oxypropylene units of 10 or more, such as a polyoxypropylene (meth)acrylate, a polyoxypropylene monomethyl ether (meth)acrylate, a polyoxypropylene monoethyl ether (meth)acrylate, a polyoxypropylene monobutylether (meth)acrylate, or a polyoxypropylene monophenyl ether (meth)acrylate.

Specific examples of the polyoxybutylene (meth)acrylate may include:

a dioxybutylene (meth)acrylate type having an addition molar number n of oxybutylene units of 2, such as dioxybutylene (meth)acrylate, dioxybutylene monomethyl ether (meth)acrylate, dioxybutylene monoethyl ether (meth)acrylate, dioxybutylene monobutyl ether (meth)acrylate, or dioxybutylene monophenyl ether (meth)acrylate;

a trioxybutylene (meth)acrylate type having an addition molar number n of oxybutylene units of 3, such as trioxybutylene (meth)acrylate, trioxybutylene monomethyl ether (meth)acrylate, trioxybutylene monoethyl ether (meth)acrylate, trioxybutylene monobutyl ether (meth)acrylate, or trioxybutylene monophenyl ether (meth)acrylate;

a tetraoxybutylene (meth)acrylate type having an addition molar number n of oxybutylene units of 4, such as tetraoxybutylene (meth)acrylate, tetraoxybutylene monomethyl ether (meth)acrylate, tetraoxybutylene monoethyl ether (meth)acrylate, tetraoxybutylene monobutyl ether (meth)acrylate, or tetraoxybutylene monophenyl ether (meth)acrylate;

a hexaoxybutylene (meth)acrylate type having an addition molar number n of oxybutylene units of 6, such as hexaoxybutylene (meth)acrylate, hexaoxybutylene monomethyl ether (meth)acrylate, hexaoxybutylene monoethyl ether (meth)acrylate, hexaoxybutylene monobutyl ether (meth)acrylate, or hexaoxybutylene monophenyl ether (meth)acrylate; and

a polyoxybutylene (meth)acrylate type having an addition molar number n of oxybutylene units of 10 or more, such as a polyoxybutylene (meth)acrylate, a polyoxybutylene monomethyl ether (meth)acrylate, a polyoxybutylene monoethyl ether (meth)acrylate, a polyoxybutylene monobutyl ether (meth)acrylate, or a polyoxybutylene monophenyl ether (meth)acrylate.

Specific examples of the polyoxytetramethylene (meth)acrylate may include:

a dioxytetramethylene (meth)acrylate type having an addition molar number n of oxytetramethylene units of 2, such as dioxytetramethylene (meth)acrylate, dioxytetramethylene monomethyl ether (meth)acrylate, dioxytetramethylene monoethyl ether (meth)acrylate, dioxytetramethylene monobutyl ether (meth)acrylate, or dioxytetramethylene monophenyl ether (meth)acrylate;

a trioxytetramethylene (meth)acrylate type having an addition molar number n of oxytetramethylene units of 3, such as trioxytetramethylene (meth)acrylate, trioxytetramethylene monomethyl ether (meth)acrylate, trioxytetramethylene monoethyl ether (meth)acrylate, trioxytetramethylene monobutyl ether (meth)acrylate, or trioxytetramethylene monophenyl ether (meth)acrylate;

a tetraoxytetramethylene (meth)acrylate type having an addition molar number n of oxytetramethylene units of 4, such as tetraoxytetramethylene (meth)acrylate, tetraoxytetramethylene monomethylether (meth)acrylate, tetraoxytetramethylene monoethyl ether (meth)acrylate, tetraoxytetramethylene monobutyl ether (meth)acrylate, or tetraoxytetramethylene monophenyl ether (meth)acrylate;

a hexaoxytetramethylene (meth)acrylate type having an addition molar number n of oxytetramethylene units of 6, such as hexaoxytetramethylene (meth)acrylate, hexaoxytetramethylene monomethyl ether (meth)acrylate, hexaoxytetramethylene monoethyl ether (meth)acrylate, hexaoxytetramethylene monobutyl ether (meth)acrylate, or hexaoxytetramethylene monophenyl ether (meth)acrylate; and

a polyoxytetramethylene (meth)acrylate type having an addition molar number n of oxytetramethylene units of 10 or more, such as a polyoxytetramethylene (meth)acrylate, a polyoxytetramethylene monomethyl ether (meth)acrylate, a polyoxytetramethylene monoethyl ether (meth)acrylate, a polyoxytetramethylene monobutyl ether (meth)acrylate, or polyoxytetramethylene monophenyl ether (meth)acrylate.

In addition to the foregoing, in the present invention, a polyoxyalkylene (meth)acrylate having two or more kinds of oxyalkylene units may be used. Specific examples of the polyoxyalkylene (meth)acrylate having two or more kinds of oxyalkylene units may include a polyoxyethylene-polyoxypropylene (meth)acrylate, a polyoxyethylene monophenyl ether-polyoxypropylene (meth)acrylate, a polyoxyethylene-polyoxybutylene (meth)acrylate, a polyoxyethylene-polyoxytetramethylene (meth)acrylate, a polyoxypropylene-polyoxybutylene (meth)acrylate, and a polyoxypropylene-polyoxytetramethylene (meth)acrylate. An addition molar number n in the case of using the polyoxyalkylene (meth)acrylate having two or more kinds of oxyalkylene units equals the total of addition molar numbers of the oxyalkylene units.

In the present invention, those polyoxyalkylene (meth)acrylates may be used alone or in combination.

In the present invention, as the polyoxyalkylene (meth)acrylate, there are preferably used, for example, trioxypropylene monomethyl ether (meth)acrylate, tetraoxypropylene monomethyl ether (meth)acrylate, pentaoxypropylene monomethyl ether (meth)acrylate, hexaoxypropylene monomethyl ether (meth)acrylate, a polyoxypropylene monomethyl ether (meth)acrylate having an addition molar number n of oxyalkylene units of 10 or more, trioxypropylene monoethyl ether (meth)acrylate, tetraoxypropylene monoethyl ether (meth)acrylate, pentaoxypropylene monoethyl ether (meth)acrylate, hexaoxypropylene monoethyl ether (meth)acrylate, and a polyoxypropylene monoethyl ether (meth)acrylate having an addition molar number n of oxyalkylene units of 10 or more, and there are particularly preferably used trioxypropylene monomethyl ether (meth)acrylate and hexaoxypropylene monomethyl ether (meth)acrylate. The polyoxyalkylene (meth)acrylate is characterized in that the amount of a di (meth)acrylate component included as an impurity is small, and has an advantage in that there is little risk of forming a gel during polymer polymerization.

Those polyoxyalkylene (meth)acrylates may be easily synthesized through reactions of the corresponding polyoxyalkylenes with acid chlorides such as acrylic acid chloride and methacrylic acid chloride or reactions of the corresponding polyoxyalkylenes with (meth)acrylic acid esters each having an isocyanate group such as 2-acryloyloxyethyl isocyanate and 2-methacryloyloxyethyl isocyanate. Alternatively, commercially available polyoxyalkylene (meth)acrylates may be used.

Commercially available materials which may be used as the polyoxyalkylene (meth)acrylates may be exemplified by: a polyoxyethylene monomethyl ether monomethacrylate (having a number average molecular weight of about 1,100, i.e., n of about 23) which is a product available from Sigma-Aldrich Corporation; products available from NOF CORPORATION under the trade name “BLEMMER PE200” (polyoxyethylene monomethacrylate having n of about 4.5), the trade name “BLEMMER PE350” (polyoxyethylene monomethacrylate having n of about 8), the trade name “BLEMMER AE200” (polyoxyethylene monoacrylate having n of about 4.5), the trade name “BLEMMER AE400” (polyoxyethylene monoacrylate having n of about 10), the trade name “BLEMMER PP-1000” (polyoxypropylene monomethacrylates having n's of 4 to 6), the trade name “BLEMMER PP-500” (polyoxypropylene monomethacrylate having n of 9), the trade name “BLEMMER PP-800” (polyoxypropylene monomethacrylate having n of 13), the trade name “BLEMMER AP-150” (polyoxypropylene monoacrylate having n of about 3), the trade name “BLEMMER AP-400” (polyoxypropylene monoacrylate having n of about 6), the trade name “BLEMMER AP-550” (polyoxypropylene monoacrylate having n of about 9), the trade name “BLEMMER PME-200” (polyoxyethylene monomethyl ether monomethacrylate having n of about 4), the trade name “BLEMMER PME-400” (polyoxyethylene monomethyl ether monoacrylate having n of about 9), the trade name “BLEMMER PME-1000” (polyoxyethylene monomethyl ether monoacrylate having n of about 23), the trade name “BLEMMER PME-4000” (polyoxyethylene monomethyl ether monoacrylate having n of about 90), the trade name “BLEMMER 50PEP-300” (polyoxyethylene-polyoxypropylene monomethacrylate), the trade name “BLEMMER 55PET-800” (polyoxyethylene-polyoxytetramethylene monomethacrylate), and the trade name “BLEMMER 43PAPE-600B” (polyoxyethylene-polyoxypropylene phenoxy ether monomethacrylate); a product available from Kyoeisha Chemical Co., Ltd. under the trade name “LIGHT ACRYLATE DPM-A” (dioxypropylene monomethyl ether acrylate); and a product available from Shin Nakamura Chemical Co., Ltd. under the trade name “AM-30PG” (trioxypropylene monomethyl acrylate).

In the present invention, the content of the monomer having a polyoxyalkylene chain is preferably 3 wt % to 78 wt %, more preferably 5 wt % to 50 wt %, still more preferably 7 wt % to 30 wt %, in all monomer components constituting the acrylic polymer (A). When the content of the monomer having a polyoxyalkylene chain falls within the range of 3 wt % to 78 wt %, there is an advantage in that, when an ether bond, which is a bond having low rotation energy (leading to a high degree of freedom in molecular rotation), is introduced into the polymer, the number of ether bonds which can be present on the surface of a pressure-sensitive adhesive is large, and thus wettability can be improved. On the other hand, when the content of the monomer having a polyoxyalkylene chain is less than 3 wt %, the ratio of the polyoxyalkylene chain which can be present on the surface of the pressure-sensitive adhesive reduces, and hence desired wettability is hardly obtained in some cases. When the content is more than 78 wt %, the ratio of an alkoxy polyalkylene glycol (meth)acrylate including a diester component as an impurity increases, and hence a gel is liable to be generated during polymer polymerization in some cases.

In the present invention, specific examples of the alkyl (meth)acrylate having an alkyl group containing 4 to 18 carbon atoms (e.g., an alkyl group containing 4 to 12 carbon atoms) include alkyl (meth)acrylates such as butyl (meth)acrylate, isobutyl (meth)acrylate, t-butyl (meth)acrylate, pentyl (meth)acrylate, amyl (meth)acrylate, isoamyl (meth)acrylate, hexyl (meth)acrylate, heptyl (meth)acrylate, octyl (meth)acrylate, isooctyl (meth)acrylate, ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, and octadecyl (meth)acrylate. Those alkyl (meth)acrylates may be used alone or in combination.

The content of the alkyl (meth)acrylate having an alkyl group containing 4 to 18 carbon atoms is preferably 2 wt % to 96.9 wt %, more preferably 32 wt % to 94.5 wt %, still more preferably 54 wt % to 92 wt %, in all monomer components.

In the present invention, the functional group-containing monomer imparts polarity and reactivity to the acrylic polymer (A) and contributes to the formation of a cross-linked structure through a reaction with a cross-linking agent to be described later, and examples thereof may include a functional group-containing monomer containing a functional group such as a carboxyl group or a hydroxyl group.

Specific examples of the functional group-containing monomer may include:

carboxyl group-containing monomers such as (meth)acrylic acid, itaconic acid, maleic acid, fumaric acid, and crotonic acid; and

hydroxyl group-containing monomers such as hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and [4-(hydroxymethyl)cyclohexyl]methyl acrylate.

Further, in the present invention, examples of the functional group-containing monomer may include:

N-hydroxyalkyl (meth)acrylamides such as N-methylol acrylamide, N-methylol methacrylamide, N-(2-hydroxyethyl)acrylamide, N-(2-hydroxyethyl)methacrylamide, N-(2-hydroxypropyl)acrylamide, N-(2-hydroxypropyl)methacrylamide, N-(1-hydroxypropyl)acrylamide, N-(1-hydroxypropyl)methacrylamide, N-(3-hydroxypropyl)acrylamide, N-(3-hydroxypropyl)methacrylamide, N-(2-hydroxybutyl)acrylamide, N-(2-hydroxybutyl)methacrylamide, N-(3-hydroxybutyl)acrylamide, N-(3-hydroxybutyl)methacrylamide, N-(4-hydroxybutyl)acrylamide, and N-(4-hydroxybutyl)methacrylamide;

monomers each having an epoxy group such as glycidyl (meth)acrylate, methylglycidyl (meth)acrylate, and allyl glycidyl ether;

monomers each having an amide group such as (meth)acrylamide, N,N-dimethyl (meth)acrylamide, N,N-diethyl (meth)acrylamide, N-isopropyl (meth)acrylamide, N-butyl (meth)acrylamide, N-methylolpropane (meth)acrylamide, N-methoxymethyl (meth)acrylamide, N-butoxymethyl (meth)acrylamide, and N-vinylcarboxylic acid amide;

monomers each having an amino group such as aminoethyl (meth)acrylate, N,N-dimethylaminoethyl (meth)acrylate, and t-butylaminoethyl (meth)acrylate;

monomers each having a cyano group such as acrylonitrile and methacrylonitrile;

monomers each having a keto group such as diacetone (meth)acrylamide, diacetone (meth)acrylate, vinyl methyl ketone, vinyl ethyl ketone, allyl acetoacetate, and vinyl acetoacetate; and

isocyanate group-containing monomers such as 2-(meth)acryloyloxyethyl isocyanate. Those functional group-containing monomers may be used alone or in combination.

The content of the functional group-containing monomer is preferably 0.1 wt % to 8 wt %, more preferably 0.5 wt % to 7 wt %, still more preferably 1 wt % to 6 wt %, in all monomer components. When the content of the functional group-containing monomer is less than 0.1 wt %, its addition effect is hardly obtained. For example, cross-link formation becomes insufficient, the cohesive force of the pressure-sensitive adhesive composition cannot be obtained, the pressure-sensitive adhesive sheet becomes misaligned in fixing an article, and an adhesive residue occurs in peeling the pressure-sensitive adhesive sheet in some cases. On the other hand, when the content of the functional group-containing monomer is more than 8 wt %, the cohesive force of the acrylic polymer (A) increases, and hence the fluidity reduces, with the result that the wettability reduces in some cases.

In the present invention, for example, a copolymerizable monomer for adjusting the glass transition point and adhesion property of the acrylic polymer (A) may be used as another monomer component constituting the acrylic polymer (A) in such a range that the effects of the present invention are not impaired. Examples of such copolymerizable monomer may include:

alkyl (meth)acrylates each having an alkyl group containing less than 4 carbon atoms such as methyl (meth)acrylate, ethyl (meth)acrylate, propyl (meth)acrylate, and isopropyl (meth)acrylate;

vinyl esters such as vinyl acetate and vinyl propionate;

aromatic vinyl compounds such as styrene, substituted styrenes (e.g., α-methylstyrene), and vinyltoluene;

alicyclic hydrocarbon (meth)acrylates such as cyclohexyl (meth)acrylate, cyclopentyl di(meth)acrylate, and isobornyl (meth)acrylate;

aromatic ring-containing (meth)acrylates such as phenyl (meth)acrylate, phenoxyethyl (meth)acrylate, and benzyl (meth)acrylate;

olefin-based monomers such as ethylene, propylene, isoprene, butadiene, and isobutylene;

halogen atom-containing monomers such as vinyl chloride and vinylidene chloride;

alkoxy group-containing monomers such as methoxyethyl (meth)acrylate and ethoxyethyl (meth)acrylate;

vinyl ether-based monomers such as methyl vinyl ether and ethyl vinyl ether; and

monomers each having a heterocycle such as N-vinyl-2-pyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, N-(meth)acryloylmorpholine, and tetrahydrofurfuryl (meth)acrylate.

In the present invention, as the copolymerizable monomer, monomers each having a plurality of functional groups in one molecule may be used alone or in appropriate combination. Such polyfunctional monomer can be useful for improving the heat resistance and cohesiveness of a pressure-sensitive adhesive. Specific examples of the polyfunctional monomer include: mono- or polyalkylene glycol di(meth)acrylates such as ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, and (poly)propylene glycol di(meth)acrylate; and neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, tetramethylolmethane tri(meth)acrylate, dipentaerythritol hexa(meth)acrylate, and divinylbenzene.

As the copolymerizable monomer, monomers each having an alkoxysilyl group may be used alone or in appropriate combination. Such alkoxysilyl group-containing monomer can be useful for improving the heat resistance and cohesiveness of a pressure-sensitive adhesive. Specific examples of the alkoxysilyl group-containing monomer include (meth)acryloxyalkylsilane derivatives such as 3-(meth)acryloxypropyltrimethoxysilane, 3-(meth)acryloxypropyltriethoxysilane, 3-(meth)acryloxypropylmethyldimethoxysilane, 3-(meth)acryloxypropylmethyldiethoxysilane, and vinyltrimethoxysilane.

Such copolymerizable monomers may be used alone or in appropriate combination. For example, the copolymerizable monomer may be used in the range of 12 wt % or less (0 wt % to 12 wt %) in all monomer components, and the use amount thereof is generally set to 11 wt % or less (0 wt % to 11 wt %), preferably 10 wt % or less (0 wt % to 10 wt %). The lower limit of the use amount in the case of using the copolymerizable monomer is not particularly limited and has only to be such an amount that the use purpose of the monomer can be achieved. In general, the use amount of the copolymerizable monomer is suitably set to 0.001 wt % or more in all monomer components.

The acrylic polymer (A) having a polyoxyalkylene chain in a side chain to be used in the present invention may be produced by polymerization of the monomer components by any of known polymerization methods such as solution polymerization, bulk polymerization, emulsion polymerization, and various radical polymerizations. Further, the acrylic polymer (A) may be any of a random copolymer, a block copolymer, a graft copolymer, and the like.

It should be noted that, in the solution polymerization, ethyl acetate, toluene, ethanol, or the like is used as a polymerization solvent. A mixture of those solvents may also be used as a polymerization solvent. A specific example of the solution polymerization is as follows: a reaction is generally performed under the reaction conditions of about 50° C. to 70° C. and 2 hours or more (e.g., about 5 hours to 30 hours) by adding a polymerization initiator under a stream of an inert gas such as nitrogen.

A polymerization initiator, a chain transfer agent, an emulsifier, or the like to be used in the radical polymerization is not particularly limited and may be appropriately selected before use. It should be noted that the weight average molecular weight of the acrylic polymer (A) to be described later can be controlled by the use amount of the polymerization initiator or chain transfer agent and reaction conditions, and the use amount is appropriately adjusted depending on kinds thereof.

Examples of the polymerization initiator may include, but not limited to: azo-based initiators such as 2,2′-azobisisobutyronitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine] hydrate (product available from Wako Pure Chemical Industries, Ltd. under the trade name VA-057); persulfates such as potassium persulfate and ammonium persulfate; peroxide-based initiators such as di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, and hydrogen peroxide; and redox-based initiators each using a peroxide and a reducing agent in combination such as a combination of a persulfate and sodium hydrogen sulfite and a combination of a peroxide and sodium ascorbate.

The polymerization initiators may be used alone or in combination, and the total content thereof is preferably about 0.005 part by weight to 1 part by weight, more preferably about 0.02 part by weight to 0.5 part by weight, with respect to 100 parts by weight of all monomer components.

Examples of the chain transfer agent include laurylmercaptan, glycidyl mercaptan, mercaptoacetic acid, 2-mercaptoethanol, thioglycolic acid, 2-ethylhexyl thioglycolate, and 2,3-dimercapto-1-propanol. The chain transfer agents may be used alone or in combination, and the total content thereof is about 0.1 part by weight or less with respect to 100 parts by weight of all monomer components.

Further, an emulsifier to be used in the case of the emulsion polymerization is exemplified by: anionic emulsifiers such as sodium lauryl sulfate, ammonium lauryl sulfate, sodium dodecylbenzenesulfonate, an ammonium polyoxyethylene alkyl ether sulfate, and a sodium polyoxyethylene alkyl phenyl ether sulfate; and nonionic emulsifiers such as a polyoxyethylene alkyl ether, a polyoxyethylene alkyl phenyl ether, a polyoxyethylene fatty acid ester, and a polyoxyethylene-polyoxypropylene block polymer. Those emulsifiers may be used alone or in combination.

In addition, as a reactive emulsifier, there is given an emulsifier having introduced therein a radically polymerizable functional group such as a propenyl group or an allyl ether group. Specific examples thereof include AQUALON HS-10, HS-20, KH-10, BC-05, BC-10, and BC-20 (products available from Dai-ichi Kogyo Seiyaku Co., Ltd.) and ADEKA REASOAP SE10N (product available from ADEKA CORPORATION). The reactive emulsifier is incorporated into a polymer chain after polymerization, leading to an improvement in water resistance, and hence is preferably used. The use amount of the emulsifier is preferably 0.3 to 5 parts by weight, more preferably, from the viewpoints of polymerization stability and mechanical stability, 0.5 to 1 part by weight, with respect to 100 parts by weight of the total amount of monomer components. It should be noted that, when an emulsifier corresponding to the polyoxyalkylene oligomer (B) to be described later is used to perform polymerization, the emulsifier included in a pressure-sensitive adhesive composition prepared by using a polymer solution to be obtained is regarded as the polyoxyalkylene oligomer (B).

It is desired that the thus obtained acrylic polymer (A) have a weight average molecular weight of 50,000 to 2,000,000, preferably 100,000 to 1,500,000, still more preferably 300,000 to 1,000,000. When the weight average molecular weight is less than 50,000, there is a tendency that the pressure-sensitive adhesive composition becomes misaligned upon adhesive fixation owing to a reduction in its cohesive force, and causes an adhesive residue upon peeling. On the other hand, when the weight average molecular weight is more than 2,000,000, there is a tendency that the fluidity of the polymer reduces and the wettability reduces. It should be noted that the weight average molecular weight can be measured by gel permeation chromatography (GPC) and calculated in terms of polystyrene.

(Polyoxyalkylene Oligomer (B))

The polyoxyalkylene oligomer (B) which may be used in the present invention may be represented by, for example, any one of the following general formulae (3) to (5).

HO—(R⁸O)ₘ—H (3)

R⁹—O—(R⁸O)ₘ—H (4)

R⁹—O—(R⁸O)ₘ—R¹⁰ (5)

In this case, the general formula (3) represents a polyoxyalkylene having hydroxyl groups at both terminals, the general formula (4) represents a polyoxyalkylene alkyl ether having an alkyl group R⁹ introduced into a hydroxyl group at one terminal through an ether bond (referred to as polyoxyalkylene monoalkyl ether), and the general formula (5) represents a polyoxyalkylene alkyl ether having alkyl groups R⁹ and R¹⁰ respectively introduced into hydroxyl groups at both terminals through ether bonds (referred to as polyoxyalkylene dialkyl ether).

In the general formulae (3) to (5), R⁸ preferably represents a C₂ to C₄ alkylene group, and examples thereof may include an ethylene group (—CH₂CH₂—) a propylene group (—CH₂CH(CH₃)—), a butylene group (—CH₂CH(CH₂CH₃)—), and a tetramethylene group (—CH₂CH₂CH₂CH₂—). Further, R⁸ may represent one kind of alkylene group or may represent two or more kinds of alkylene groups. That is, in the general formulae (3) to (5), (R⁸O)ₘ may represent a block copolymer or random copolymer of two or more kinds of oxyalkylene groups. In the present invention, R⁸ preferably represents a propylene group particularly from the viewpoint of having a low freezing point (pour point) and high lipophilicity (low surface free energy).

Further, in the general formulae (3) to (5), m represents an addition molar number of oxyalkylene (R⁸O) units. In the present invention, m represents 2 to 500, preferably 3 to 400, and may represent, for example, 3 to 100, or for example, 4 to 50. When the addition molar number m of oxyalkylene units represents 2 to 500, there is an advantage in that the polyoxyalkylene oligomer is a liquid at a general use temperature (25° C.) and hence can achieve sufficient wettability. On the other hand, when the addition molar number m represents less than 2, there is a drawback in that the polyoxyalkylene oligomer has a low boiling point and thus evaporates together with an organic solvent during a formation of the pressure-sensitive adhesive, which makes it difficult to stably express the wettability in some cases. When the addition molar number m represents more than 500, some polyoxyalkylene alkyl ethers are present as solids, and hence the degree of freedom in molecular rotation reduces in some cases.

In the general formulae (4) and (5), R⁹ and R¹⁰ each represent a C₁ to C₂₀ alkyl group (aliphatic hydrocarbon group) or an aromatic substituent. Examples of the C₁ to C₂₀ aliphatic hydrocarbon group may include a methyl group, an ethyl group, a propyl group, an isopropyl group, a butyl group, an isobutyl group, a t-butyl group, a pentyl group, a hexyl group, a heptyl group, an octyl group, an isooctyl group, a 2-ethylhexyl group, a nonyl group, a decyl group, an isodecyl group, an undecyl group, a tridecyl group, a tetradecyl group, a pentadecyl group, a hexadecyl group, a heptadecyl group, an octadecyl group, and an eicosyl group. Further, examples of the aromatic substituent may include a phenyl group, a methylphenyl group, and a naphthyl group. In the present invention, R⁹ and R¹⁰ each represent preferably an alkyl group, particularly preferably a methyl group, an ethyl group, or a 2-ethylhexyl group, from the viewpoint of having high lipophilicity (low surface free energy). Further, in the general formula (5), R⁹ and R¹⁰ may represent the same alkyl group or may represent different alkyl groups. In a preferred case, R⁹ represents a methyl group and R¹⁰ represents a 2-ethylhexyl group.

In the present invention, the molecular weight of the polyoxyalkylene oligomer is preferably 200 to 20,000, more preferably 300 to 19,000, still more preferably 400 to 18,000. When the molecular weight of the polyoxyalkylene oligomer falls within the range of 200 to 20,000, there is an advantage in that the polyoxyalkylene oligomer is a liquid at a general use temperature (25° C.) and hence can achieve sufficient wettability. On the other hand, when the molecular weight is less than 200, the polyoxyalkylene oligomer has a low boiling point and thus evaporates together with an organic solvent during a formation of the pressure-sensitive adhesive, which makes it difficult to stably express the wettability in some cases. When the molecular weight is more than 20,000, the degree of freedom in molecular rotation of the polyoxyalkylene oligomer reduces, with the result that an improvement in wettability cannot be achieved in some cases.

It should be noted that, in the present invention, the molecular weight of the polyoxyalkylene oligomer is a molecular weight derived from an individual molecular structure. Further, in the case of using a commercially available product or the like, which includes a mixture of a plurality of addition molar numbers of oxyalkylene units, its number average molecular weight is regarded as its molecular weight.

Specific examples of the polyoxyalkylene oligomer which may be used in the present invention may include:

polyoxyalkylenes such as a polyoxyethylene, a polyoxypropylene, a polyoxybutylene, and a polyoxytetramethylene;

polyoxyalkylene monoalkyl ethers such as a polyoxyethylene monomethyl ether, a polyoxyethylene monoethyl ether, a polyoxyethylene mono(2-ethylhexyl)ether, a polyoxypropylene monomethyl ether, a polyoxypropylene monoethyl ether, a polyoxypropylene mono(2-ethylhexyl)ether, a polyoxybutylene monomethyl ether, a polyoxybutylene monoethyl ether, a polyoxybutylene mono(2-ethylhexyl)ether, a polyoxytetramethylene monomethyl ether, a polyoxytetramethylene monoethyl ether, and a polyoxytetramethylene mono(2-ethylhexyl)ether; and

polyoxyalkylene dialkyl ethers such as a polyoxyethylene dimethyl ether, a polyoxyethylene diethyl ether, a polyoxyethylene di(2-ethylhexyl)ether, a polyoxypropylene dimethyl ether, a polyoxypropylene diethyl ether, a polyoxypropylene di(2-ethylhexyl)ether, a polyoxybutylene dimethyl ether, a polyoxybutylene diethyl ether, a polyoxybutylene di(2-ethylhexyl)ether, a polyoxytetramethylene dimethyl ether, a polyoxytetramethylene diethyl ether, and a polyoxytetramethylene di(2-ethylhexyl)ether.

In addition to the foregoing, in the present invention, a polyoxyalkylene oligomer having two or more kinds of oxyalkylene units may be used. Specific examples of the polyoxyalkylene oligomer having two or more kinds of oxyalkylene units may include a polyoxyethylene-polyoxypropylene, a polyoxyethylene-polyoxypropylene monoalkyl ether, and a polyoxyethylene-polyoxypropylene dialkyl ether. The addition molar number m in the case of using the polyoxyalkylene oligomer having two or more kinds of oxyalkylene units equals the total of addition molar numbers of the oxyalkylene units. Further, a polyoxyalkylene glyceryl ether may be used the polyoxyalkylene oligomer (B). An alkyl group of the polyoxyalkylene glyceryl ether is exemplified by the same groups as those described above for R⁹. Further, the oxyalkylene units and addition molar number thereof may be the same as those described above for the general formulae (3) to (5).

In the present invention, those polyoxyalkylene oligomers (B) may be used alone or in combination.

Specific examples of the polyoxyalkylene oligomer which may be used in the present invention may include: products available from NOF CORPORATION under the trade name “UNIOX M-400” (polyoxyethylene monomethyl ether having a number average molecular weight of 400), the trade name “UNIOX M-550” (polyoxyethylene monomethyl ether having a number average molecular weight of 500), the trade name “UNIOX M-1000” (polyoxyethylene monomethyl ether having a number average molecular weight of 1,000), the trade name “UNIOX M-2000” (polyoxyethylene monomethyl ether having a number average molecular weight of 2,000), the trade name “UNIOX MM-500” (polyoxyethylene dimethyl ether having a number average molecular weight of 550), the trade name “UNIOL PB-500” (polyoxybutylene having a number average molecular weight of 500), and the trade name “UNIOL PB-700” (polyoxybutylene having a number average molecular weight of 700); products available from Kao Corporation under the trade name “SMACK MP-40” (polyoxypropylene monomethyl ether having a molecular weight of 264) and the trade name “SMACK MP-70” (polyoxypropylene monomethyl ether having a molecular weight of 439); products available from Sanyo Chemical Industries, Ltd. under the trade name “PEG-400” (polyoxyethylene having a number average molecular weight of 400), the trade name “PEG-2000” (polyoxyethylene having a number average molecular weight of 2,000), the trade name “SANNIX PP-400” (polyoxypropylene having a number average molecular weight of 400), the trade name “SANNIX PP-2000” (polyoxypropylene having a number average molecular weight of 2,000), the trade name “NEWPOL LB-3000” (polyoxypropylene monobutyl ether having a number average molecular weight of 2,800), the trade name “NEWPOL GP-400” (polyoxypropylene glyceryl ether having a number average molecular weight of 400 (average number of functional groups: 3)), the trade name “NEWPOL GP-3000” (polyoxypropylene glyceryl ether having a number average molecular weight of 3,000 (average number of functional groups: 3)), the trade name “NEWPOL 50HB-55” (polyoxyethylene-polyoxypropylene monomethyl ether having a number average molecular weight of 240), the trade name “NEWPOL 50HB-260” (polyoxyethylene-polyoxypropylene monomethyl ether having a number average molecular weight of 880), the trade name “NEWPOL 50HB-2000” (polyoxyethylene-polyoxypropylene monomethyl ether having a number average molecular weight of 2,300), the trade name “NEWPOL PE-64” (polyoxyethylene-polyoxypropylene block polymer having a number average molecular weight of 1,750), and the trade name “SANFLEX GPA-3000” (terminal-esterified polyfunctional polyether); products available from Lion Corporation under the trade name “LEOCON 1015B” (polyoxypropylene monobutyl ether having a molecular weight of 950), the trade name “LEOCON 1015H” (polyoxypropylene mono(2-ethylhexyl)ether having a molecular weight of 800), and the trade name “LEOCON 1020H” (polyoxyethylene-polyoxypropylene mono(2-ethylhexyl)ether having a molecular weight of 1,200); products available from ASAHI GLASS CO., LTD. under the trade name “PREMINOL S 1004F” (polyoxypropylene monoalkyl ether having a molecular weight of 3,300), the trade name “PREMINOL S 1005” (polyoxypropylene monoalkyl ether having a molecular weight of 5,000), the trade name “PREMINOL S 4011” (polyoxypropylene monoalkyl ether having a molecular weight of 10,000), the trade name “PREMINOL 4013F” (polyoxypropylene having a molecular weight of 12,000), the trade name “PREMINOL 4015” (polyoxypropylene having a molecular weight of 15,000), the trade name “PREMINOL 4318F” (polyoxypropylene having a molecular weight of 18,000), the trade name “PREMINOL 3011” (polyoxypropylenetriol having a molecular weight of 10,000 (number of functional groups: 3)), and the trade name “PREMINOL 3015” (polyoxypropylene having a molecular weight of 15,000 (number of functional groups: 3)); and products available from AOKI OIL INDUSTRIAL CO., LTD. under the trade name “FINESURF NDB-800” (monodecyl ether of a polyoxyethylene-polyoxypropylene block polymer having T.M.W. of 450), the trade name “FINESURF NDB-1000” (monodecyl ether of a polyoxyethylene-polyoxypropylene block polymer having T.M.W. of 550), the trade name “FINESURF NDB-1400” (monodecyl ether of a polyoxyethylene-polyoxypropylene block polymer having T.M.W. of 700), the trade name “BLAUNON BUP-1900” (monobutyl ether of a polyoxypropylene having T.M.W. of 1,900), and the trade name “BLAUNON NFB-2040” (mono(2-ethylhexyl)ether of a polyoxyethylene-polyoxypropylene block polymer having T.M.W. of 1,300).

The pressure-sensitive adhesive composition of the present invention contains 5 to 150 parts by weight of the polyoxyalkylene oligomer (B) with respect to 100 parts by weight of the acrylic polymer (A) having a polyoxyalkylene chain in a side chain. The content of the polyoxyalkylene oligomer (B) is, for example, 10 to 150 parts by weight, preferably 10 to 120 parts by weight, more preferably 15 to 100 parts by weight. When the content of the polyoxyalkylene oligomer (B) falls within the range of 5 to 150 parts by weight with respect to 100 parts by weight of the acrylic polymer (A), the wettability of a pressure-sensitive adhesive can be improved. On the other hand, when the content of the polyoxyalkylene oligomer (B) is less than 5 parts by weight, there is a drawback in that the ratio of the polyoxyalkylene chain which can be present on the surface of a pressure-sensitive adhesive reduces, and hence desired wettability is hardly obtained. When the content is more than 150 parts by weight, there is a drawback in that, when the polyoxyalkylene oligomer, which is a liquid, is charged into a compounded liquid for a pressure-sensitive adhesive, the viscosity of the liquid reduces, resulting in a deterioration in applicability.

The pressure-sensitive adhesive composition of the present invention contains the polyoxyalkylene oligomer (B) with respect to the acrylic polymer (A) having a polyoxyalkylene chain in a side chain. Any appropriate combination may be adopted as a combination of the acrylic polymer (A) and the polyoxyalkylene oligomer (B). From the viewpoint of additionally improving the wettability, it is preferred to use, as the acrylic polymer (A), an acrylic polymer having a polyoxypropylene monoalkyl ether chain and/or a hexaoxypropylene monomethyl ether chain, and to use, as the polyoxyalkylene oligomer (B), a polyoxypropylene alkyl ether. In addition, it is more preferred to use, as the acrylic polymer (A), an acrylic polymer having a trioxypropylene monomethyl ether chain or a hexaoxypropylene monomethyl ether chain, and to use, as the polyoxyalkylene oligomer (B), a polyoxypropylene monomethyl ether. It is considered that, when those components are used in combination, a polyoxyalkylene in the polymer and a polyoxyalkylene in the oligomer can be present in large amounts in the vicinity of a surface through their interaction, leading to an additional improvement in wettability.

(Cross-Linking Agent)

The pressure-sensitive adhesive composition of the present invention may contain a cross-linking agent. Examples of the cross-linking agent to be used in the present invention include an isocyanate compound, an epoxy-based resin, a melamine-based resin, an aziridine derivative, and a metal chelate compound.

An isocyanate-based cross-linking agent is preferably used as the cross-linking agent in the present invention, from the viewpoint of providing an appropriate cohesive force by cross-link formation through a reaction with the acrylic polymer (A).

The isocyanate-based cross-linking agent to be used as the cross-linking agent refers to a compound having two or more isocyanate groups (including isocyanate reproduction type functional groups having isocyanate groups temporarily protected, for example, with a blocking agent or by multimerization) in one molecule.

Examples of the isocyanate-based cross-linking agent include: aromatic isocyanates such as tolylene diisocyanate and xylene diisocyanate; alicyclic isocyanates such as isophorone diisocyanate; and aliphatic isocyanates such as hexamethylene diisocyanate.

More specific examples thereof may include: lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and a polymethylene polyphenyl isocyanate; isocyanate adducts such as a trimethylolpropane/tolylene diisocyanate trimer adduct (product available from NIPPON POLYURETHANE INDUSTRY CO., LTD. under the trade name CORONATE L), a trimethylolpropane/hexamethylene diisocyanate trimer adduct (product available from NIPPON POLYURETHANE INDUSTRY CO., LTD. under the trade name CORONATE HL), and an isocyanurate form of hexamethylene diisocyanate (product available from NIPPON POLYURETHANE INDUSTRY CO., LTD. under the trade name CORONATE HX); a polyether polyisocyanate and a polyester polyisocyanate; and adducts thereof with various polyols, and polyisocyanates polyfunctionalized with an isocyanurate bond, a biuret bond, an allophanate bond, and the like. Of those, it is preferred to use an aliphatic isocyanate because of a high reaction rate.

Further, examples of the epoxy-based resin include N,N,N′,N′-tetraglycidyl-m-xylenediamine, 1,3-bis(N,N-diglycidylaminomethyl)cyclohexane, ethylene glycol diglycidyl ether, propylene glycol diglycidyl ether, terephthalic acid diglycidyl ester acrylate, and spiroglycol diglycidyl ether. Examples of the melamine-based resin include hexamethylol melamine. Examples of the aziridine derivative include products commercially available from Sogo Pharmaceutical Co., Ltd. under the trade name HDU, the trade name TAZM, and the trade name TAZO. Further, examples of the metal chelate compound include metal chelate compounds containing: metal components such as aluminum, iron, tin, titanium, and nickel; and chelate components such as acetylene, methyl acetoacetate, and ethyl lactate.

The content of the cross-linking agent to be used in the present invention is preferably 1 part by weight to 10 parts by weight, more preferably 2 parts by weight to 6 parts by weight, with respect to 100 parts by weight of the acrylic polymer (A). When the content is less than 1 part by weight, there is a tendency that cross-link formation with the cross-linking agent becomes insufficient, with the result that the cohesive force of the pressure-sensitive adhesive composition reduces. On the other hand, when the content is more than 10 parts by weight, there is a tendency that the cohesive force of the polymer increases and thus the fluidity reduces, with the result that the wettability becomes insufficient.

The pressure-sensitive adhesive composition of the present invention may contain other additives in such a range that its effects are not impaired. For example, it is possible to compound various additives such as a filler (e.g., an inorganic filler or an organic filler), an antioxidant, an antioxidizing agent, a UV absorbing agent, an antistatic agent, a lubricant, a surfactant, a plasticizer, a surface lubricating agent, a leveling agent, and a colorant (e.g., a pigment or a dye).

A pressure-sensitive adhesive layer of the present invention includes the above-mentioned pressure-sensitive adhesive composition. When the pressure-sensitive adhesive composition includes a cross-linking agent, the layer is obtained through cross-linking of the above-mentioned pressure-sensitive adhesive composition. Further, a pressure-sensitive adhesive sheet of the present invention includes a backing and such pressure-sensitive adhesive layer formed on the backing. In that case, the pressure-sensitive adhesive composition is generally cross-linked after the application of the pressure-sensitive adhesive composition. Alternatively, a pressure-sensitive adhesive layer including the cross-linked pressure-sensitive adhesive composition may be transferred onto a supporting film or the like.

The pressure-sensitive adhesive layer is produced by, for example, a method involving: applying the pressure-sensitive adhesive composition onto a backing; removing a polymerization solvent and the like by drying; and subjecting the resultant to cross-linking treatment as necessary, thereby forming a pressure-sensitive adhesive layer on the backing, or a method involving: applying the pressure-sensitive adhesive composition onto a release liner (e.g., a silicone-treated release film) or the like subjected to release treatment; removing a polymerization solvent and the like by drying; and as necessary, subjecting the resultant to cross-linking treatment, thereby forming a pressure-sensitive adhesive layer, followed by transfer onto a backing. It should be noted that, in the application of the pressure-sensitive adhesive composition, one or more kinds of solvents except the polymerization solvent may be newly added as appropriate.

As the backing, there may be used, for example, any of: plastic films such as a film made of a polyolefin (e.g., a polyethylene, a polypropylene, or an ethylene-propylene copolymer), a film made of a polyester (e.g., a polyethylene terephthalate), a film made of a vinyl chloride-based resin, a film made of a vinyl acetate-based resin, a film made of a polyimide-based resin, a film made of a polyamide-based resin, a film made of a fluorine-based resin, and cellophanes; papers such as Japanese paper, kraft paper, glassine paper, high-quality paper, synthetic paper, and top coat paper; clothes such as woven fabrics and nonwoven fabrics made of one or a mixture of two or more of various fibrous substances (which may be any of natural fibers, semi-synthetic fibers, and synthetic fibers, and are, for example, cotton fiber, staple fiber, Manila hemp, pulp, rayon, acetate fiber, polyester fiber, polyvinyl alcohol fiber, polyamide fiber, and polyolefin fiber); rubber sheets made of a natural rubber and a butyl rubber; foam sheets made of foams such as a foamed polyurethane and a foamed polychloroprene rubber; metal foils such as an aluminum foil and a copper foil; and complexes thereof. The plastic films may be of a non-stretching type or a stretching type (a uniaxial stretching type or a biaxial stretching type).

It should be noted that, in order to improve adhesiveness between the pressure-sensitive adhesive layer and the backing, a surface of the backing (in particular, a surface on which the pressure-sensitive adhesive layer is provided) may be subjected to, for example, known or commonly-used surface treatment such as corona discharge treatment, plasma treatment, or undercoating agent application. The thickness of the backing, which may be appropriately selected depending on purposes, is generally approximately 10 μm to 500 μm, preferably approximately about 10 μm to 200 μm.

Depending on its purposes, any appropriate method may be adopted as a method of drying the pressure-sensitive adhesive composition in the step of applying the pressure-sensitive adhesive composition of the present invention onto a backing or a release liner, followed by drying, thereby forming a pressure-sensitive adhesive layer as described above. A method of drying the applied film by heating is preferably employed. A heating drying temperature is preferably 40° C. to 200° C., still more preferably 50° C. to 180° C., particularly preferably 70° C. to 170° C. When the heating drying temperature falls within the range, a pressure-sensitive adhesive layer having excellent pressure-sensitive adhesive characteristics can be obtained.

Any appropriate time may be adopted as a drying time. The drying time is preferably 5 seconds to 20 minutes, still more preferably 5 seconds to 10 minutes, particularly preferably 10 seconds to 5 minutes.

Various methods are employed as a method of forming the pressure-sensitive adhesive layer. Specific examples thereof include methods such as roll coating, kiss-roll coating, gravure coating, reverse coating, roll brushing, spray coating, dip roll coating, bar coating, knife coating, air knife coating, curtain coating, lip coating, and an extrusion coating method using a die coater.

The thickness of the pressure-sensitive adhesive layer is not particularly limited, and for example, is about 1 μm to 100 μm, preferably 2 μm to 50 μm, more preferably 2 μm to 40 μm, still more preferably 5 μm to 35 μm.

The pressure-sensitive adhesive sheet of the present invention includes the above-mentioned pressure-sensitive adhesive layer having high wettability, and hence is excellent in wettability as compared to a conventional acrylic pressure-sensitive adhesive sheet. The wettability to an adherend can be evaluated by a method described in Examples to be described later. The pressure-sensitive adhesive sheet wets and spreads over a distance of 100 mm in a time of preferably less than 10 seconds, more preferably 7 seconds or less, still more preferably 5 seconds or less. When the wetting time is less than seconds, the pressure-sensitive adhesive sheet comes into sufficiently close contact with an adherend even without any particular pressurization when attached to the adherend, and is substantially free of the inclusion of air bubbles or the like.

Further, the pressure-sensitive adhesive sheet of the present invention has an adhesive strength for an acrylic plate or glass plate of preferably 0.02 N/250 mm or more, more preferably 0.05 N/250 mm or more, still more preferably 0.10 N/250 mm or more (generally 2.00 N/250 mm or less).

The pressure-sensitive adhesive layer to be obtained is excellent in wettability, and hence the present invention is useful in the fields of various pressure-sensitive adhesive sheets, for example, a pressure-sensitive adhesive sheet for electrical insulation, a double-coated pressure-sensitive adhesive sheet, a pressure-sensitive adhesive sheet for surface protection, a tape for masking, and a re-peelable label.

Examples and the like which specifically show constructions and effects of the present invention are described below. However, the present invention is by no means limited thereto. It should be noted that evaluation items in Examples and the like were measured in the following manner.

<Measurement of Weight Average Molecular Weight>

The weight average molecular weight of a produced polymer was measured by gel permeation chromatography (GPC) and calculated in terms of polystyrene.

Apparatus: HLC-8220 GPC, a product available from Tosoh Corporation

Column: TSKgel Super HZM-H, H-RC, and HZ-H, products available from Tosoh Corporation
Flow rate: 0.6 ml/min
Injection amount: 20 μl
Column temperature: 40° C.

### Eluent: THF

Injection sample concentration: 0.1 wt %

<Evaluation of Wettability>

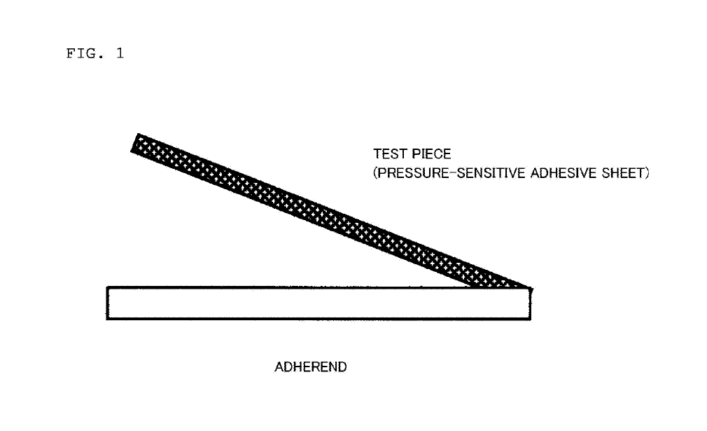

Test piece: 25 mm×100 mm
Adherend: glass plate (product available from Matsunami Glass Ind., Ltd. under the trade name soda-lime glass cut edges (ground edges): 100 mm×100 mm×1.35 mm)
Number of times of measurement: 3
Measurement environment: (temperature: 23° C., humidity: 50% RH)
(1) FIG. 1 illustrates the state of a glass plate and a test piece before attachment in the measurement of wettability. As illustrated in FIG. 1, an angle, which is formed by the glass plate and the test piece in a state in which part of the surface of a pressure-sensitive adhesive layer of the test piece (pressure-sensitive adhesive sheet) was brought into contact with the glass plate, was set to 20° to 30°.
(2) Next, the test piece, from which a hand was released, was attached to the glass plate by its own weight only. A time for the pressure-sensitive adhesive layer to wet and spread to the end of the glass plate (over a distance of 100 mm) from the moment of the release of the hand was recorded. An average of the three measurements was defined as a wetting time, and a case where the wetting time was less than 10 seconds was rated as acceptable.

<Measurement of Adhesive Strength>

Each of the produced pressure-sensitive adhesive sheets was cut into a size having a width of 250 mm and a length of 150 mm, and was crimped onto a clean acrylic plate (product available from MITSUBISHI RAYON CO., LTD. under the trade name ACRYLITE L), which had been cleaned by performing reciprocating rubbing ten times with a clean waste impregnated with isopropyl alcohol, and the glass plate by a method involving performing reciprocating rolling of a 2-kg roller once. Thus, an evaluation sample for an adhesive strength was prepared. The evaluation sample was left to stand under the measurement environment of 23° C. and 50% RH for 30 minutes. After that, an adhesive strength [N/250 mm] was measured through use of a tensile tester under the conditions of a tensile speed of 300 mm/min and a peel angle of 180°.

### Example 1

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 10 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (A) was prepared. The resultant acrylic polymer had a weight average molecular weight of 770,000.

<Production of Pressure-Sensitive Adhesive Sheet Using Pressure-Sensitive Adhesive Composition>

100 Parts by weight (solid content) of the acrylic polymer solution (A) were used, 50 parts by weight of a polyoxypropylene monomethyl ether having a molecular weight of 439 (product available from Kao Corporation under the trade name “SMACK MP-70”), 4 parts by weight of an isocyanurate form of hexamethylene diisocyanate (product available from NIPPON POLYURETHANE INDUSTRY CO., LTD. under the trade name “CORONATE HX”) as a cross-linking agent, and 0.015 part by weight of dioctyltin dilaurate (product available from Tokyo Fine Chemical CO., LTD. under the trade name “OL-1”) as a catalyst were added, and the mixture was diluted with toluene so that the solid content was 29 wt %, and was then stirred. Thus, a pressure-sensitive adhesive composition solution was obtained.

The pressure-sensitive adhesive composition solution was applied onto a product available from Toray Industries, Inc. under the trade name “Lumirror S10” as a polyethylene terephthalate (PET) film having a thickness of 38 μm, and was dried at 130° C. for 30 seconds to remove a solvent. Thus, a pressure-sensitive adhesive layer (thickness: 20 μm) was formed. After that, the pressure-sensitive adhesive layer was covered with a releasing film surface-treated with a releasing agent, and was cured at 50° C. for 1 day. Thus, a pressure-sensitive adhesive sheet was obtained.

### Example 2

### Production of Pressure-Sensitive Adhesive Sheet Using Pressure-Sensitive Adhesive Composition

A pressure-sensitive adhesive sheet was obtained in the same manner as in Example 1 except that the compounding amount of the polyoxypropylene monomethyl ether having a molecular weight of 439 (product available from Kao Corporation under the trade name “SMACK MP-70”) was changed to 15 parts by weight.

### Example 3

### Preparation of Acrylic Polymer

A four-necked flask equipped with a stirring blade, a temperature gauge, a nitrogen gas inlet, a condenser, and a dropping funnel was fed with 72 parts by weight of 2-ethylhexyl acrylate (2EHA), 4 parts by weight of 2-hydroxyethyl acrylate (HEA), 24 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (B) was prepared. The resultant acrylic polymer had a weight average molecular weight of 750,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (B) were used in place of 100 parts by weight of the acrylic polymer solution (A); and the compounding amount of the polyoxypropylene monomethyl ether having a molecular weight of 439 (product available from Kao Corporation under the trade name “SMACK MP-70”) was changed to 15 parts by weight.

### Example 4

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 10 parts by weight of dioxypropylene monomethyl ether acrylate having an addition molar number of oxypropylene units of 2 (product available from Kyoeisha Chemical Co., Ltd. under the trade name “LIGHT ACRYLATE DPM-A”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (C) was prepared. The resultant acrylic polymer had a weight average molecular weight of 510,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (C) were used in place of 100 parts by weight of the acrylic polymer solution (A).

### Example 5

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 10 parts by weight of hexaoxypropylene monomethyl ether acrylate having an addition molar number of oxypropylene units of 6, 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (D) was prepared. The resultant acrylic polymer had a weight average molecular weight of 530,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (D) were used in place of 100 parts by weight of the acrylic polymer solution (A); and the compounding amount of the polyoxypropylene monomethyl ether having a molecular weight of 439 (product available from Kao Corporation under the trade name “SMACK MP-70”) was changed to 15 parts by weight.

### Example 6

### Preparation of Acrylic Polymer

A four-necked flask equipped with a stirring blade, a temperature gauge, a nitrogen gas inlet, a condenser, and a dropping funnel was fed with 58 parts by weight of 2-ethylhexyl acrylate (2EHA), 4 parts by weight of 2-hydroxyethyl acrylate (HEA), 38 parts by weight of dioxyethylene monoethyl ether acrylate having an addition molar number of oxyethylene units of 2 (product available from Osaka Organic Chemical Industry Ltd. under the trade name “V#190”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (E) was prepared. The resultant acrylic polymer had a weight average molecular weight of 580,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (E) were used in place of 100 parts by weight of the acrylic polymer solution (A).

### Example 7

### Preparation of Acrylic Polymer

A four-necked flask equipped with a stirring blade, a temperature gauge, a nitrogen gas inlet, a condenser, and a dropping funnel was fed with 19 parts by weight of 2-ethylhexyl acrylate (2EHA), 4 parts by weight of 2-hydroxyethyl acrylate (HEA), 77 parts by weight of dioxyethylene monoethyl ether acrylate having an addition molar number of oxyethylene units of 2 (product available from Osaka Organic Chemical Industry Ltd. under the trade name “V#190”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (F) was prepared. The resultant acrylic polymer had a weight average molecular weight of 810,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (F) were used in place of 100 parts by weight of the acrylic polymer solution (A).

### Example 8

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 10 parts by weight of a mixture of polyoxypropylene monomethacrylates having addition molar numbers of oxypropylene units of 4 to 6 (product available from NOF CORPORATION under the trade name “BLEMMER PP-1000”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (G) was prepared. The resultant acrylic polymer had a weight average molecular weight of 590,000.

<Production of Pressure-Sensitive Adhesive Sheet Using Pressure-Sensitive Adhesive Composition

A pressure-sensitive adhesive sheet was obtained in the same manner as in Example 1 except that 100 parts by weight (solid content) of the acrylic polymer solution (G) were used in place of 100 parts by weight of the acrylic polymer solution (A).

### Example 9

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 10 parts by weight of a polyoxyethylene-polyoxypropylene phenoxy ether monomethacrylate (product available from NOF CORPORATION under the trade name “BLEMMER 43PAPE-600B”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (H) was prepared. The resultant acrylic polymer had a weight average molecular weight of 420,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (H) were used in place of 100 parts by weight of the acrylic polymer solution (A).

### Example 10

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (C) were used in place of 100 parts by weight of the acrylic polymer solution (A); and 50 parts by weight of a polyoxypropylene mono(2-ethylhexyl)ether having a molecular weight of 800 (product available from Lion Corporation under the trade name “LEOCON 1015H”) were compounded in place of 50 parts by weight of the polyoxypropylene monomethyl ether having a molecular weight of 439 (product available from Kao Corporation under the trade name “SMACK MP-70”).

### Example 11

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (C) were used in place of 100 parts by weight of the acrylic polymer solution (A); and 50 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Example 12

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (C) were used in place of 100 parts by weight of the acrylic polymer solution (A); and 25 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Example 13

### Preparation of Acrylic Polymer

A four-necked flask equipped with a stirring blade, a temperature gauge, a nitrogen gas inlet, a condenser, and a dropping funnel was fed with 19 parts by weight of 2-ethylhexyl acrylate (2EHA), 4 parts by weight of 2-hydroxyethyl acrylate (HEA), 77 parts by weight of dioxypropylene monomethyl ether acrylate having an addition molar number of oxypropylene units of 2 (product available from Kyoeisha Chemical Co., Ltd. under the trade name “LIGHT ACRYLATE DPM-A”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (I) was prepared. The resultant acrylic polymer had a weight average molecular weight of 720,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (I) were used in place of 100 parts by weight of the acrylic polymer solution (A); and 50 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Example 14

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (I) were used in place of 100 parts by weight of the acrylic polymer solution (A); and 25 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Example 15

### Production of Pressure-Sensitive Adhesive Sheet Using Pressure-Sensitive Adhesive Composition

A pressure-sensitive adhesive sheet was obtained in the same manner as in Example 1 except that 50 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Example 16

### Production of Pressure-Sensitive Adhesive Sheet Using Pressure-Sensitive Adhesive Composition

A pressure-sensitive adhesive sheet was obtained in the same manner as in Example 1 except that 25 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Example 17

### Preparation of Acrylic Polymer

A four-necked flask equipped with a stirring blade, a temperature gauge, a nitrogen gas inlet, a condenser, and a dropping funnel was fed with 77 parts by weight of 2-ethylhexyl acrylate (2EHA), 4 parts by weight of 2-hydroxyethyl acrylate (HEA), 19 parts by weight of dioxypropylene monomethyl ether acrylate having an addition molar number of oxypropylene units of 2 (product available from Kyoeisha Chemical Co., Ltd. under the trade name “LIGHT ACRYLATE DPM-A”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (J) was prepared. The resultant acrylic polymer had a weight average molecular weight of 720,000.

<Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (J) were used in place of 100 parts by weight of the acrylic polymer solution (A); and 15 parts by weight of a polyoxypropylene monobutyl ether having a molecular weight of 950 (product available from Lion Corporation under the trade name “LEOCON 1015B”) were compounded in place of 50 parts by weight of the polyoxypropylene monomethyl ether having a molecular weight of 439 (product available from Kao Corporation under the trade name “SMACK MP-70”).

### Example 18

### Production of Pressure-Sensitive Adhesive Sheet Using Pressure-Sensitive Adhesive Composition

A pressure-sensitive adhesive sheet was obtained in the same manner as in Example 1 except that 65 parts by weight of a polyoxybutylene having a number average molecular weight of 700 (product available from NOF CORPORATION under the trade name “UNIOL PB-700”) were compounded in place of 50 parts by weight of the polyoxypropylene monomethyl ether having a molecular weight of 439 (product available from Kao Corporation under the trade name “SMACK MP-70”).

### Example 19

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (F) were used in place of 100 parts by weight of the acrylic polymer solution (A); and 25 parts by weight of a polyoxyethylene dimethyl ether having a number average molecular weight of 550 (product available from NOF CORPORATION under the trade name “UNIOX MM-550”) were compounded in place of 50 parts by weight of the polyoxypropylene monomethyl ether having a molecular weight of 439 (product available from Kao Corporation under the trade name “SMACK MP-70”).

### Example 20

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (C) were used in place of 100 parts by weight of the acrylic polymer solution (A); 50 parts by weight of a polyoxypropylene mono(2-ethylhexyl)ether having a molecular weight of 800 (product available from Lion Corporation under the trade name “LEOCON 1015H”) were compounded in place of 50 parts by weight of the polyoxypropylene monomethyl ether having a molecular weight of 439 (product available from Kao Corporation under the trade name “SMACK MP-70”); and 4 parts by weight of a trimethylolpropane/tolylene diisocyanate trimer adduct (product available from NIPPON POLYURETHANE INDUSTRY CO., LTD. under the trade name “CORONATE L”) were compounded in place of 4 parts by weight of the isocyanurate form of hexamethylene diisocyanate (product available from NIPPON POLYURETHANE INDUSTRY CO., LTD. under the trade name “CORONATE HX”) as the cross-linking agent.

### Example 21

### Preparation of Acrylic Polymer

A four-necked flask equipped with a stirring blade, a temperature gauge, a nitrogen gas inlet, a condenser, and a dropping funnel was fed with 83 parts by weight of 2-ethylhexyl acrylate (2EHA), 4 parts by weight of acrylic acid (AA), 4 parts by weight of 2-hydroxyethyl acrylate (HEA), 9 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (K) was prepared. The resultant acrylic polymer had a weight average molecular weight of 680,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (K) were used in place of 100 parts by weight of the acrylic polymer solution (A); 50 parts by weight of a polyoxypropylene mono(2-ethylhexyl)ether having a molecular weight of 800 (product available from Lion Corporation under the trade name “LEOCON 1015H”) were compounded in place of 50 parts by weight of the polyoxypropylene monomethyl ether having a molecular weight of 439 (product available from Kao Corporation under the trade name “SMACK MP-70”); and 4 parts by weight of a trimethylolpropane/tolylene diisocyanate trimer adduct (product available from NIPPON POLYURETHANE INDUSTRY CO., LTD. under the trade name “CORONATE L”) were compounded in place of 4 parts by weight of the isocyanurate form of hexamethylene diisocyanate (product available from NIPPON POLYURETHANE INDUSTRY CO., LTD. under the trade name “CORONATE HX”) as the cross-linking agent.

### Example 22

### Preparation of Acrylic Polymer

A four-necked flask equipped with a stirring blade, a temperature gauge, a nitrogen gas inlet, a condenser, and a dropping funnel was fed with 70 parts by weight of 2-ethylhexyl acrylate (2EHA), 17 parts by weight of butyl acrylate (BA), 4 parts by weight of 2-hydroxyethyl acrylate (HEA), 9 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (L) was prepared. The resultant acrylic polymer had a weight average molecular weight of 720,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (L) were used in place of 100 parts by weight of the acrylic polymer solution (A); and 50 parts by weight of a polyoxypropylene mono(2-ethylhexyl)ether having a molecular weight of 800 (product available from Lion Corporation under the trade name “LEOCON 1015H”) were compounded in place of 50 parts by weight of the polyoxypropylene monomethyl ether having a molecular weight of 439 (product available from Kao Corporation under the trade name “SMACK MP-70”).

### Example 23

### Preparation of Acrylic Polymer

A four-necked flask equipped with a stirring blade, a temperature gauge, a nitrogen gas inlet, a condenser, and a dropping funnel was fed with 83 parts by weight of 2-ethylhexyl acrylate (2EHA), 4 parts by weight of methyl methacrylate (MMA), 4 parts by weight of 2-hydroxyethyl acrylate (HEA), 9 parts by weight of dioxypropylene monomethyl ether acrylate having an addition molar number of oxypropylene units of 2 (product available from Kyoeisha Chemical Co., Ltd. under the trade name “LIGHT ACRYLATE DPM-A”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (M) was prepared. The resultant acrylic polymer had a weight average molecular weight of 450,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (M) were used in place of 100 parts by weight of the acrylic polymer solution (A); and 50 parts by weight of a polyoxypropylene mono(2-ethylhexyl)ether having a molecular weight of 800 (product available from Lion Corporation under the trade name “LEOCON 1015H”) were compounded in place of 50 parts by weight of the polyoxypropylene monomethyl ether having a molecular weight of 439 (product available from Kao Corporation under the trade name “SMACK MP-70”).

### Example 24

### Production of Pressure-Sensitive Adhesive Sheet Using Pressure-Sensitive Adhesive Composition

A pressure-sensitive adhesive sheet was obtained in the same manner as in Example 1 except that: 150 parts by weight of a polyoxypropylene monoalkyl ether having a number average molecular weight of 10,000 (product available from ASAHI GLASS CO., LTD. under the trade name “PREMINOL S 4011”) were compounded in place of 50 parts by weight of the polyoxypropylene monomethyl ether having a molecular weight of 439 (product available from Kao Corporation under the trade name “SMACK MP-70”); and 4 parts by weight of a trimethylolpropane/tolylene diisocyanate trimer adduct (product available from NIPPON POLYURETHANE INDUSTRY CO., LTD. under the trade name “CORONATE L”) were compounded in place of 4 parts by weight of the isocyanurate form of hexamethylene diisocyanate (product available from NIPPON POLYURETHANE INDUSTRY CO., LTD. under the trade name “CORONATE HX”) as the cross-linking agent.

### Example 25

### Production of Pressure-Sensitive Adhesive Sheet Using Pressure-Sensitive Adhesive Composition

A pressure-sensitive adhesive sheet was obtained in the same manner as in Example 1 except that: 100 parts by weight of a polyoxypropylenetriol having a number average molecular weight of 10,000 (product available from ASAHI GLASS CO., LTD. under the trade name “PREMINOL S 3011”) were compounded in place of 50 parts by weight of the polyoxypropylene monomethyl ether having a molecular weight of 439 (product available from Kao Corporation under the trade name “SMACK MP-70”); and 4 parts by weight of a trimethylolpropane/tolylene diisocyanate trimer adduct (product available from NIPPON POLYURETHANE INDUSTRY CO., LTD. under the trade name “CORONATE L”) were compounded in place of 4 parts by weight of the isocyanurate form of hexamethylene diisocyanate (product available from NIPPON POLYURETHANE INDUSTRY CO., LTD. under the trade name “CORONATE HX”) as the cross-linking agent.

### Example 26

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 3 parts by weight of acrylic acid (AA), 10 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (O) was prepared. The resultant acrylic polymer had a weight average molecular weight of 770,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (O) were used in place of 100 parts by weight of the acrylic polymer solution (A).

### Example 27

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 4 parts by weight of N-vinyl-2-pyrrolidone (NVP), 10 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (P) was prepared. The resultant acrylic polymer had a weight average molecular weight of 770,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (P) were used in place of 100 parts by weight of the acrylic polymer solution (A).

### Example 28

### Preparation of Acrylic Polymer

A four-necked flask equipped with a stirring blade, a temperature gauge, a nitrogen gas inlet, a condenser, and a dropping funnel was fed with 86 parts by weight of 2-ethylhexyl acrylate (2EHA), 4 parts by weight of 2-hydroxyethyl acrylate (HEA), 3 parts by weight of methyl methacrylate (MMA), 10 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (Q) was prepared. The resultant acrylic polymer had a weight average molecular weight of 770,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (Q) were used in place of 100 parts by weight of the acrylic polymer solution (A).

### Example 29

### Preparation of Acrylic Polymer

A four-necked flask equipped with a stirring blade, a temperature gauge, a nitrogen gas inlet, a condenser, and a dropping funnel was fed with 21 parts by weight of 2-ethylhexyl acrylate (2EHA), 4 parts by weight of 2-hydroxyethyl acrylate (HEA), 65 parts by weight of ethyl acrylate (EA), 10 parts by weight of trioxypropylene methyl ether acrylate having an addition molar number of oxypropylene units of 3 (product available from Shin Nakamura Chemical Co., Ltd. under the trade name “AM-30PG”), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (R) was prepared. The resultant acrylic polymer had a weight average molecular weight of 770,000.

<Production of Pressure-Sensitive Adhesive Sheet Using Pressure-Sensitive Adhesive Composition>

A pressure-sensitive adhesive sheet was obtained in the same manner as in Example 1 except that 100 parts by weight (solid content) of the acrylic polymer solution (R) were used in place of 100 parts by weight of the acrylic polymer solution (A).

### Comparative Example 1

### Preparation of Acrylic Polymer

A four-necked flask equipped with a stirring blade, a temperature gauge, a nitrogen gas inlet, a condenser, and a dropping funnel was fed with 96 parts by weight of 2-ethylhexyl acrylate (2EHA), 4 parts by weight of 2-hydroxyethyl acrylate (HEA), 0.2 part by weight of azobisisobutyronitrile as a polymerization initiator, and 185 parts by weight of ethyl acetate. A nitrogen gas was introduced into the gently stirred mixture, and a polymerization reaction was performed for about 3 hours while the liquid temperature in the flask was kept at around 60° C. Thus, an acrylic polymer solution (N) was prepared. The resultant acrylic polymer had a weight average molecular weight of 430,000.

<Production of Pressure-Sensitive Adhesive Sheet Using Pressure-Sensitive Adhesive Composition>

A pressure-sensitive adhesive sheet was obtained in the same manner as in Example 1 except that: 100 parts by weight (solid content) of the acrylic polymer solution (N) were used in place of 100 parts by weight of the acrylic polymer solution (A); and the polyoxypropylene monomethyl ether having a molecular weight of 439 (product available from Kao Corporation under the trade name “SMACK MP-70”) was not compounded.

### Comparative Example 2

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (N) were used in place of 100 parts by weight of the acrylic polymer solution (A); and 25 parts by weight of a mono(2-ethylhexyl)ether of a polyoxyethylene-polyoxypropylene block polymer having a molecular weight of 1,400 (product available from Lion Corporation under the trade name “LEOCON 1020H”) were compounded in place of 50 parts by weight of the polyoxypropylene monomethyl ether having a molecular weight of 439 (product available from Kao Corporation under the trade name “SMACK MP-70”).

### Comparative Example 3

### Production of Pressure-Sensitive Adhesive Sheet Using Pressure-Sensitive Adhesive Composition

A pressure-sensitive adhesive sheet was obtained in the same manner as in Example 1 except that the polyoxypropylene monomethyl ether having a molecular weight of 439 (product available from Kao Corporation under the trade name “SMACK MP-70”) was not compounded.

### Comparative Example 4

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (G) were used in place of 100 parts by weight of the acrylic polymer solution (A); and the polyoxypropylene monomethyl ether having a molecular weight of 439 (product available from Kao Corporation under the trade name “SMACK MP-70”) was not compounded.

### Comparative Example 5

### Production of Pressure-Sensitive Adhesive Sheet Using Pressure-Sensitive Adhesive Composition

A pressure-sensitive adhesive sheet was obtained in the same manner as in Example 1 except that: 100 parts by weight (solid content) of the acrylic polymer solution (F) were used in place of 100 parts by weight of the acrylic polymer solution (A); and the polyoxypropylene monomethyl ether having a molecular weight of 439 (product available from Kao Corporation under the trade name “SMACK MP-70”) was not compounded.

Each of the pressure-sensitive adhesive sheets produced in Examples and Comparative examples was evaluated for its wettability and adhesion property by the above-mentioned evaluation methods. Table 1 to Table 4 show the results.

TABLE 1

| | Acrylic polymer | | | | | | | | | | | | | | |
|---|---|---|---|---|---|---|---|---|---|---|---|---|---|---|---|
| | | Polyoxyalkylene (meth)acrylate | | | | | | Additive | | | | | | | |
| | | R⁵—(R⁶O)n—R⁷ | | | | | | Polyoxyalkylene oligomer | | | | | | Cross-linking | |
| | | | Main | | | Other monomers | | R⁹—O—(R⁸O)m—R¹⁰ | | | | | | agent | |
| | | | skel- | | Com- | | Com- | | | | | | Com- | | Com- |
| | | Ter- | eton | Ter- | pound- | | pound- | | Ter- | | Ter- | Mo- | pound- | | pound- |
| | | mi- | (R⁶O)/ | mi- | ing | | ing | | mi- | Main | mi- | lec- | ing | | ing |
| | | nal | Addition | nal | amount | | amount | | nal | skel- | nal | u- | amount | | amount |
| | | group | molar | group | [parts by | Compo- | [parts by | | group | eton | group | lar | [parts by | | [parts by |
| | Kind | (R⁵) | number n | (R⁷) | weight] | sition | weight] | Kind | (R⁹) | (R⁸O) | (R¹⁰) | weight | weight] | Kind | weight] |
| Example | (A) | AC | PO/3 | Me | 10 | 2EHA/HEA | 86/4 | MP-70 | Me | PO | H | 439 | 50 | C/HX | 4 |
| 1 | | | | | | | | | | | | | | | |
| Example | (A) | AC | PO/3 | Me | 10 | 2EHA/HEA | 86/4 | MP-70 | Me | PO | H | 439 | 15 | C/HX | 4 |
| 2 | | | | | | | | | | | | | | | |
| Example | (B) | AC | PO/3 | Me | 24 | 2EHA/HEA | 72/4 | MP-70 | Me | PO | H | 439 | 15 | C/HX | 4 |
| 3 | | | | | | | | | | | | | | | |
| Example | (C) | AC | PO/2 | Me | 10 | 2EHA/HEA | 86/4 | MP-70 | Me | PO | H | 439 | 50 | C/HX | 4 |
| 4 | | | | | | | | | | | | | | | |
| Example | (D) | AC | PO/6 | Me | 10 | 2EHA/HEA | 86/4 | MP-70 | Me | PO | H | 439 | 15 | C/HX | 4 |
| 5 | | | | | | | | | | | | | | | |
| Example | (E) | AC | EO/2 | Et | 38 | 2EHA/HEA | 58/4 | MP-70 | Me | PO | H | 439 | 50 | C/HX | 4 |
| 6 | | | | | | | | | | | | | | | |
| Example | (F) | AC | EO/2 | Et | 77 | 2EHA/HEA | 19/4 | MP-70 | Me | PO | H | 439 | 50 | C/HX | 4 |
| 7 | | | | | | | | | | | | | | | |
| Example | (G) | MA | PO/4 to 6 | H | 10 | 2EHA/HEA | 86/4 | MP-70 | Me | PO | H | 439 | 50 | C/HX | 4 |
| 8 | | | | | | | | | | | | | | | |
| Example | (H) | MA | EO/6 and | Ph | 10 | 2EHA/HEA | 86/4 | MP-70 | Me | PO | H | 439 | 50 | C/HX | 4 |
| 9 | | | PO/6 | | | | | | | | | | | | |
| Example | (C) | AC | PO/2 | Me | 10 | 2EHA/HEA | 86/4 | 1015H | 2EH | PO | H | 800 | 50 | C/HX | 4 |
| 10 | | | | | | | | | | | | | | | |
| Example | (C) | AC | PO/2 | Me | 10 | 2EHA/HEA | 86/4 | 1020H | 2EH | EO/PO | H | 1,400 | 50 | C/HX | 4 |
| 11 | | | | | | | | | | | | | | | |
| Example | (C) | AC | PO/2 | Me | 10 | 2EHA/HEA | 86/4 | 1020H | 2EH | EO/PO | H | 1,400 | 25 | C/HX | 4 |
| 12 | | | | | | | | | | | | | | | |

*In the table, Me represents a methyl group, Et represents an ethyl group, 2EH represents a 2-ethylhexyl group, Ph represents a phenyl group, AC represents an acryloyl group, MA represents a methacryloyl group, PO represents an oxypropylene group, and EO represents an oxyethylene group.

TABLE 2

| | Acrylic polymer | | | | | | | | | | | | | | |
|---|---|---|---|---|---|---|---|---|---|---|---|---|---|---|---|
| | | Polyoxyalkylene (meth)acrylate | | | | | | Additive | | | | | | | |
| | | R⁵—(R⁶O)n—R⁷ | | | | | | Polyoxyalkylene oligomer | | | | | | Cross-linking | |
| | | | Main | | | Other monomers | | R⁹—O—(R⁸O)m—R¹⁰ | | | | | | agent | |
| | | | skel- | | Com- | | Com- | | | | | | Com- | | Com- |
| | | Ter- | eton | Ter- | pound- | | pound- | | Ter- | | Ter- | Mo- | pound- | | pound- |
| | | mi- | (R⁶O)/ | mi- | ing | | ing | | mi- | Main | mi- | lec- | ing | | ing |
| | | nal | Addition | nal | amount | | amount | | nal | skel- | nal | u- | amount | | amount |
| | | group | molar | group | [parts by | Compo- | [parts by | | group | eton | group | lar | [parts by | | [parts by |
| | Kind | (R⁵) | number n | (R⁷) | weight] | sition | weight] | Kind | (R⁹) | (R⁸O) | (R¹⁰) | weight | weight] | Kind | weight] |
| Example | (I) | AC | PO/2 | Me | 77 | 2EHA/HEA | 19/4 | 1020H | 2EH | EO/PO | H | 1,400 | 50 | C/HX | 4 |
| 13 | | | | | | | | | | | | | | | |
| Example | (I) | AC | PO/2 | Me | 77 | 2EHA/HEA | 19/4 | 1020H | 2EH | EO/PO | H | 1,400 | 25 | C/HX | 4 |
| 14 | | | | | | | | | | | | | | | |
| Example | (A) | AC | PO/3 | Me | 10 | 2EHA/HEA | 86/4 | 1020H | 2EH | EO/PO | H | 1,400 | 50 | C/HX | 4 |
| 15 | | | | | | | | | | | | | | | |
| Example | (A) | AC | PO/3 | Me | 10 | 2EHA/HEA | 86/4 | 1020H | 2EH | EO/PO | H | 1,400 | 25 | C/HX | 4 |
| 16 | | | | | | | | | | | | | | | |
| Example | (J) | AC | PO/2 | Me | 19 | 2EHA/HEA | 77/4 | 1015B | Bu | PO | H | 950 | 15 | C/HX | 4 |
| 17 | | | | | | | | | | | | | | | |
| Example | (A) | AC | PO/3 | Me | 10 | 2EHA/HEA | 86/4 | PB700 | H | BO | H | 700 | 65 | C/HX | 4 |
| 18 | | | | | | | | | | | | | | | |
| Example | (F) | AC | EO/2 | Et | 77 | 2EHA/HEA | 19/4 | MM500 | Me | EO | Me | 550 | 25 | C/HX | 4 |
| 19 | | | | | | | | | | | | | | | |
| Example | (C) | AC | PO/2 | Me | 10 | 2EHA/HEA | 86/4 | 1015H | 2EH | PO | H | 800 | 50 | C/L | 4 |
| 20 | | | | | | | | | | | | | | | |
| Example | (K) | AC | PO/3 | Me | 9 | 2EHA/AA/ | 83/4/4 | 1015H | 2EH | PO | H | 800 | 50 | C/L | 4 |
| 21 | | | | | | HEA | | | | | | | | | |
| Example | (L) | AC | PO/3 | Me | 9 | 2EHA/BA/ | 70/17/4 | 1015H | 2EH | PO | H | 800 | 50 | C/HX | 4 |
| 22 | | | | | | HEA | | | | | | | | | |
| Example | (M) | AC | PO/2 | Me | 9 | 2EHA/ | 83/4/4 | 1015H | 2EH | PO | H | 800 | 50 | C/HX | 4 |
| 23 | | | | | | MMA/HEA | | | | | | | | | |
| Example | (A) | AC | PO/3 | Me | 10 | 2EHA/HEA | 86/4 | 4011 | R | PO | R | 10,000 | 150 | C/L | 4 |
| 24 | | | | | | | | | | | | | | | |
| Example | (A) | AC | PO/3 | Me | 10 | 2EHA/HEA | 86/4 | 3011 | H | PO | H | 10,000 | 100 | C/L | 4 |
| 25 | | | | | | | | | | | | | | | |
| Example | (O) | AC | PO/3 | Me | 10 | 2EHA/AA/ | 86/3/4 | MP-70 | Me | PO | H | 439 | 50 | C/HX | 4 |
| 26 | | | | | | HEA | | | | | | | | | |
| Example | (P) | AC | PO/3 | Me | 10 | 2EHA/ | 86/4/4 | MP-70 | Me | PO | H | 439 | 50 | C/HX | 4 |
| 27 | | | | | | NVP/HEA | | | | | | | | | |
| Example | (Q) | AC | PO/3 | Me | 10 | 2EHA/ | 86/3/4 | MP-70 | Me | PO | H | 439 | 50 | C/HX | 4 |
| 28 | | | | | | MMA/HEA | | | | | | | | | |
| Example | (R) | AC | PO/3 | Me | 10 | 2EHA/EA/ | 21/65/4 | MP-70 | Me | PO | H | 439 | 50 | C/HX | 4 |
| 29 | | | | | | HEA | | | | | | | | | |

*In the table, Me represents a methyl group, Et represents an ethyl group, 2EH represents a 2-ethylhexyl group, R represents an alkyl group, AC represents an acryloyl group, PO represents an oxypropylene group, EO represents an oxyethylene group, and BO represents an oxybutylene group.

TABLE 3

| | Acrylic polymer | | | | | | | | | | | | | | |
|---|---|---|---|---|---|---|---|---|---|---|---|---|---|---|---|
| | | Polyoxyalkylene (meth)acrylate | | | | | | Additive | | | | | | | |
| | | R⁵—(R⁶O)n—R⁷ | | | | | | Polyoxyalkylene oligomer | | | | | | | |
| | | | Main | | | | | R⁹—O—(R⁸O)m—R¹⁰ | | | | | | Cross-linking agent | |
| | | | skel- | | | | | | | | | | Com- | | Com- |
| | | Ter- | eton | Ter- | | | | | Ter- | | Ter- | Mo- | pound- | | pound- |
| | | mi- | (R⁶O)/ | mi- | | | | | mi- | Main | mi- | lec- | ing | | ing |
| | | nal | Addition | nal | | Other monomers | | | nal | skel- | nal | u- | amount | | amount |
| | | group | molar | group | Ratio | Compo- | Ratio | | group | eton | group | lar | [parts by | | [parts by |
| | Kind | (R⁵) | number n | (R⁷) | [wt %] | sition | [wt %] | Kind | (R⁹) | (R⁸O) | (R¹⁰) | weight | weight] | Kind | weight] |
| Com- | (N) | — | — | — | — | 2EHA/ | 96/4 | — | — | — | — | — | — | C/HX | 4 |
| par- | | | | | | HEA | | | | | | | | | |
| ative- | | | | | | | | | | | | | | | |
| Exam- | | | | | | | | | | | | | | | |
| ple | | | | | | | | | | | | | | | |
| 1 | | | | | | | | | | | | | | | |
| Com- | (N) | — | — | — | — | 2EHA/ | 96/4 | 1020H | 2EH | EO/PO | H | 1,400 | 25 | C/HX | 4 |
| par- | | | | | | HEA | | | | | | | | | |
| ative | | | | | | | | | | | | | | | |
| Exam- | | | | | | | | | | | | | | | |
| ple | | | | | | | | | | | | | | | |
| 2 | | | | | | | | | | | | | | | |
| Com- | (A) | AC | PO/3 | Me | 10 | 2EHA/ | 86/4 | — | — | — | — | — | — | C/HX | 4 |
| par- | | | | | | HEA | | | | | | | | | |
| ative | | | | | | | | | | | | | | | |
| Exam- | | | | | | | | | | | | | | | |
| ple | | | | | | | | | | | | | | | |
| 3 | | | | | | | | | | | | | | | |
| Com- | (G) | MA | PO/4 to 6 | H | 10 | 2EHA/ | 86/4 | — | — | — | — | — | — | C/HX | 4 |
| par- | | | | | | HEA | | | | | | | | | |
| ative | | | | | | | | | | | | | | | |
| Exam- | | | | | | | | | | | | | | | |
| ple | | | | | | | | | | | | | | | |
| 4 | | | | | | | | | | | | | | | |
| Com- | (F) | AC | EO/2 | Et | 77 | 2EHA/ | 19/4 | — | — | — | — | — | — | C/HX | 4 |
| par- | | | | | | HEA | | | | | | | | | |
| ative | | | | | | | | | | | | | | | |
| Exam- | | | | | | | | | | | | | | | |
| ple | | | | | | | | | | | | | | | |
| 5 | | | | | | | | | | | | | | | |

*In the table, Me represents a methyl group, Et represents an ethyl group, 2EH represents a 2-ethylhexyl group, AC represents an acryloyl group, MA represents a methacryloyl group, PO represents an oxypropylene group, and EO represents an oxyethylene group.

TABLE 4

| Evaluation results | |
|---|---|
| Wettability | Adhesive strength |
| [sec/100 mm] | [N/250 mm] |

| | Glass plate | Acrylic plate | Glass plate |
|---|---|---|---|
| Example 1 | 3 | 0.10 | 0.07 |
| Example 2 | 8 | 0.18 | 0.10 |
| Example 3 | 7 | 0.38 | 0.17 |
| Example 4 | 5 | 0.07 | 0.04 |
| Example 5 | 5 | 0.18 | 0.07 |
| Example 6 | 7 | 0.17 | 0.11 |
| Example 7 | 7 | 0.28 | 0.22 |
| Example 8 | 7 | 0.13 | 0.15 |
| Example 9 | 5 | 0.11 | 0.08 |
| Example 10 | 3 | 0.10 | 0.04 |
| Example 11 | 5 | 0.09 | 0.06 |
| Example 12 | 6 | 0.17 | 0.11 |
| Example 13 | 5 | 0.62 | 0.07 |
| Example 14 | 6 | 0.60 | 0.06 |
| Example 15 | 7 | 0.07 | 0.06 |
| Example 16 | 7 | 0.16 | 0.08 |
| Example 17 | 7 | 0.51 | 0.28 |
| Example 18 | 4 | 0.18 | 0.18 |
| Example 19 | 2 | 0.66 | 0.02 |
| Example 20 | 4 | 0.20 | 0.11 |
| Example 21 | 5 | 0.70 | 0.50 |
| Example 22 | 3 | 0.19 | 0.05 |
| Example 23 | 5 | 0.13 | 0.04 |
| Example 24 | 9 | 0.21 | 0.19 |
| Example 25 | 6 | 0.20 | 0.17 |
| Example 26 | 4 | 0.13 | 0.08 |
| Example 27 | 4 | 0.13 | 0.09 |
| Example 28 | 3 | 0.11 | 0.08 |
| Example 29 | 4 | 0.14 | 0.10 |
| Comparative | 26 | 0.85 | 0.35 |
| Example 1 | | | |
| Comparative | 10 | 0.15 | 0.12 |
| Example 2 | | | |
| Comparative | 12 | 1.15 | 0.42 |
| Example 3 | | | |
| Comparative | 12 | 1.10 | 0.52 |
| Example 4 | | | |
| Comparative | 20 | 0.66 | 0.50 |
| Example 5 | | | |

Abbreviations in the tables represent the following commercially available products.

MP-70: product available from Kao Corporation under the trade name “SMACK MP-70” (polyoxypropylene monomethyl ether having a molecular weight of 439)

1015H: product available from Lion Corporation under the trade name “LEOCON 1015H” (polyoxypropylene mono(2-ethylhexyl)ether having a molecular weight of 800)

1020H: product available from Lion Corporation under the trade name “LEOCON 1020H” (mono(2-ethylhexyl)ether of a polyoxyethylene-polyoxypropylene block polymer having a molecular weight of 1,400)

1015B: product available from Lion Corporation under the trade name “LEOCON 1015B” (polyoxypropylene monobutyl ether having a molecular weight of 950)

PB-700: product available from NOF CORPORATION under the trade name “UNIOL PB-700” (polyoxybutylene having a number average molecular weight of 700)

MM-500: product available from NOF CORPORATION under the trade name “UNIOX MM-550” (polyoxyethylene dimethyl ether having a number average molecular weight of 550)

4011: product available from ASAHI GLASS CO., LTD. under the trade name “PREMINOL S 4011” (polyoxypropylene monoalkyl ether having a number average molecular weight of 10,000)

3011: product available from ASAHI GLASS CO., LTD. under the trade name “PREMINOL S 3011” (polyoxypropylenetriol having a number average molecular weight of 10,000)

C/HX: product available from NIPPON POLYURETHANE INDUSTRY CO., LTD. under the trade name “CORONATE HX” (isocyanurate form of hexamethylene diisocyanate)

C/L: product available from NIPPON POLYURETHANE INDUSTRY CO., LTD. under the trade name “CORONATE L” (trimethylolpropane/tolylene diisocyanate trimer adduct)

The above-mentioned results confirmed that satisfactory wettability was obtained in each of the pressure-sensitive adhesive sheets according to Examples using the pressure-sensitive adhesive composition containing 5 to 150 parts by weight of the polyoxyalkylene oligomer (B) with respect to 100 parts by weight of the acrylic polymer (A) having a polyoxyalkylene chain in a side chain.

On the other hand, Comparative Example 1, which does not include any acrylic polymer having a polyoxyalkylene group in a side chain and does not include any polyoxyalkylene oligomer, is poor in wettability. Comparative Example 2, which includes a polyoxyalkylene oligomer, and Comparative Examples 3 to 5, each of which includes an acrylic polymer having a polyoxyalkylene chain in a side chain, are poor in wettability as compared to Examples satisfying both the requirements. This confirms that higher wettability is expressed by using the acrylic polymer having a polyoxyalkylene chain in a side chain and the polyoxyalkylene oligomer in combination.

What is claimed is:

1. A pressure-sensitive adhesive composition, comprising:
an acrylic polymer (A) having a polyoxyalkylene chain in a side chain; and
a polyoxyalkylene oligomer (B),
wherein a content of the polyoxyalkylene oligomer (B) is 5 to 150 parts by weight with respect to 100 parts by weight of the acrylic polymer (A).

2. A pressure-sensitive adhesive composition according to claim 1, wherein the acrylic polymer (A) has a polyoxypropylene chain as the polyoxyalkylene chain.

3. A pressure-sensitive adhesive composition according to claim 1, wherein the acrylic polymer (A) has a polyoxyalkylene alkyl ether chain as the polyoxyalkylene chain.

4. A pressure-sensitive adhesive composition according to claim 1, wherein the acrylic polymer (A) has a polyoxyalkylene chain having an addition molar number of oxyalkylene units of 3 or more.

5. A pressure-sensitive adhesive composition according to claim 1, wherein the acrylic polymer (A) has at least one of a trioxypropylene monomethyl ether chain and a hexaoxypropylene monomethyl ether chain as the polyoxyalkylene chain.

6. A pressure-sensitive adhesive composition according to claim 1, wherein: the acrylic polymer (A) comprises, as a monomer component, a monomer having a polyoxyalkylene chain; and a content of the monomer having a polyoxyalkylene chain is 3 to 78 wt % with respect to a total weight of all monomer components.

7. A pressure-sensitive adhesive composition according to claim 1, wherein the acrylic polymer (A) comprises, as monomer components, 2 to 96.9 wt % of an alkyl (meth)acrylate having an alkyl group containing 4 to 18 carbon atoms, 3 to 78 wt % of a monomer having a polyoxyalkylene chain, and 0.1 to 8 wt % of a functional group-containing monomer.

8. A pressure-sensitive adhesive composition according to claim 7, wherein the acrylic polymer (A) further comprises, as a monomer component, another copolymerizable monomer at a content of 12 wt % or less.

9. A pressure-sensitive adhesive composition according to claim 6, wherein the monomer having a polyoxyalkylene chain comprises one of trioxypropylene monomethyl ether (meth)acrylate and hexaoxypropylene monomethyl ether (meth)acrylate.

10. A pressure-sensitive adhesive composition according to claim 1, wherein the polyoxyalkylene oligomer (B) comprises a polyoxypropylene.

11. A pressure-sensitive adhesive composition according to claim 1, wherein the polyoxyalkylene oligomer (B) comprises a polyoxyalkylene alkyl ether.

12. A pressure-sensitive adhesive composition according to claim 11, wherein the polyoxyalkylene oligomer (B) comprises a polyoxypropylene alkyl ether.

13. A pressure-sensitive adhesive composition according to claim 11, wherein an alkyl group constituting the polyoxyalkylene alkyl ether comprises one of a methyl group and a 2-ethylhexyl group.

14. A pressure-sensitive adhesive composition according to claim 1, wherein the polyoxyalkylene oligomer (B) has a molecular weight of 200 to 20,000.

15. A pressure-sensitive adhesive composition according to claim 1, wherein: the acrylic polymer (A) comprises an acrylic polymer having at least one of a polyoxypropylene monoalkyl ether chain and a hexaoxypropylene monomethyl ether chain; and the polyoxyalkylene oligomer (B) comprises a polyoxypropylene alkyl ether.

16. A pressure-sensitive adhesive composition according to claim 1, further comprising 1 to 10 parts by weight of a cross-linking agent with respect to 100 parts by weight of the acrylic polymer (A).

17. A pressure-sensitive adhesive composition according to claim 16, wherein the cross-linking agent comprises an isocyanate-based cross-linking agent.

18. A pressure-sensitive adhesive layer, comprising the pressure-sensitive adhesive composition according to claim 1.

19. A pressure-sensitive adhesive sheet, comprising:
a backing; and
the pressure-sensitive adhesive layer according to claim 18 formed on the backing.
